(19) United States
(12) Patent Application Publication
(10) Pub. No.: US 2007/0201897 A1
(43) Pub. Date: Aug. 30, 2007

(54) Image forming apparatus and image forming method

(75) Inventors: Masahiro Maeda, Nagano-ken (JP); Keiichi Taguchi, Nagano-ken (JP)

Correspondence Address: HOGAN & HARTSON L.L.P., 1999 AVENUE OF THE STARS, SUITE 1400, LOS ANGELES, CA, 90067, US

(73) Assignee: SEIKO EPSON CORPORATION

(21) Appl. No.: 11/487,179

(22) Filed: Jul. 14, 2006

(30) Foreign Application Priority Data
Jul. 15, 2005 (JP) 2005-207123
Jul. 15, 2005 (JP) 2005-207125
Jul. 15, 2005 (JP) 2005-207126
Aug. 11, 2005 (JP) 2005-233084
Aug. 11, 2005 (JP) 2005-233085

(51) Int. Cl. G03G 15/16; G03G 21/00

(52) U.S. Cl. 399/101; 399/350

(57) ABSTRACT

An image forming apparatus comprises: a photosensitive member which is capable of carrying an electrostatic latent image and rotates in a predetermined direction; a developer which visualizes with toner the electrostatic latent image carried on the photosensitive member and forms a toner image; an intermediate transfer member which temporarily carries the toner image transferred from the photosensitive member; a photosensitive member cleaner which abuts on a surface of the photosensitive member and removes toner adhering on the photosensitive member; an intermediate transfer member cleaner which abuts on a surface of the intermediate transfer member and removes toner adhering on the intermediate transfer member; and a controller which executes toner accumulating processing during which a toner-accumulating patch image including a predetermined first area and a predetermined second area is formed on the photosensitive member, toner in the first area is transferred onto the intermediate transfer member and the intermediate transfer member cleaner removes the toner, thereby accumulating the toner in an abutting section between the intermediate transfer member and the intermediate transfer member cleaner, while the photosensitive member cleaner removes toner in the second area, thereby accumulating the toner in an abutting section between the photosensitive member and the photosensitive member cleaner, wherein the first area is formed in a different surface area within the surface of the photosensitive member from an area in which the second area is created during an immediately preceding rotation of the photosensitive member.

### CROSS REFERENCE TO RELATED APPLICATIONS

The entire disclosures of the descriptions, the drawings and the claims in the following Japanese patent applications are incorporated herein by reference in their entireties:

No. 2005-207123 filed on Jul. 15, 2005;

No. 2005-207125 filed on Jul. 15, 2005;

No. 2005-207126 filed on Jul. 15, 2005;

No. 2005-233084 filed on Aug. 11, 2005; and

No. 2005-233085 filed on Aug. 11, 2005.

### BACKGROUND

1. Technical Field

The present invention relates to an image forming apparatus which comprises cleaners which abut on the surface of a photosensitive member and an intermediate transfer member respectively and accordingly remove toner, and also to an image forming method for such an image forming apparatus.

2. Related Art

Among conventional image forming apparatuses of the electrophotographic type is known an apparatus which comprises a cleaner which removes toner left adhering to an image carrier which is capable of carrying a toner image. For this type of apparatus, a technique has been proposed which requires accumulating a constant amount of toner in an abutting section where the image carrier and the cleaner contact each other to thereby mitigate friction between the image carrier and the cleaner. For instance, the image forming apparatuses described in Japanese Patent No. 3248217 comprises cleaners each abutting on each one of a photosensitive member and a paper transporter and accordingly removing toner. In this apparatus, a part of a formed toner image is transferred onto a paper transporter belt and the cleaners abutting on the photosensitive member and the paper transporter scrape it off, thereby accumulating toner in an abutting section where the photosensitive member and the associated cleaner abut on each other and in an abutting section where the paper transporter and the associated cleaner abut on each other.

In an image forming apparatus comprising a photosensitive member and an intermediate transfer member serving as image carriers and cleaners each abutting on each one of the photosensitive member and the intermediate transfer member, it is necessary to supply a proper amount of toner to each one of an abutting section where the photosensitive member and the associated cleaner abut on each other and an abutting section where the intermediate transfer member and the associated cleaner abut on each other. If processing of sending toner to each abutting section is realized through a series of operations, it will be efficient. However, the conventional techniques do not sufficiently consider a specific processing mechanism of efficiently feeding in toner to both the abutting section between the photosensitive member and the associated cleaner and the abutting section between the intermediate transfer member and the associated cleaner.

### SUMMARY

An advantage of this invention is efficient processing of accumulating proper amounts of toner to an abutting section where a photosensitive member and an associated cleaner abut on each other and an abutting section where an intermediate transfer member and an associated cleaner abut on each other.

According to one aspect of the invention, the following toner accumulating processing is executed in an image forming apparatus for and an image forming method of visualizing with toner an electrostatic latent image carried on a photosensitive member, forming a toner image and transferring the toner image to an intermediate transfer member. During this toner accumulating processing, a toner-accumulating toner image is formed on the photosensitive member, and a part of the toner-accumulating toner image is transferred onto the intermediate transfer member from the photosensitive member. Following this, an intermediate transfer member cleaner abutting on the intermediate transfer member removes toner adhering to the intermediate transfer member while a photosensitive member cleaner abutting on the photosensitive member removes toner adhering to the photosensitive member.

According to this aspect, a part of the toner-accumulating toner image formed through one image forming operation is transferred onto the intermediate transfer member and fed into an abutting section with the intermediate transfer member cleaner. The portion of the toner-accumulating toner image not transferred onto the intermediate transfer member stays on the photosensitive member and is fed to an abutting section with the photosensitive member cleaner. In other words, the toner constituting the toner-accumulating toner image is allocated between the photosensitive member and the intermediate transfer member and each fed to the associated abutting section with the associated cleaner. In this manner, through one image forming operation, it is possible to feed toner to both the abutting section where the photosensitive member and the photosensitive member cleaner abut on each other and the abutting section where the intermediate transfer member and the intermediate transfer member cleaner abut on each other, thus realizing efficient toner accumulating processing.

The inventor of the invention found through various experiments that after removal of a toner image formed on a photosensitive member with a cleaner which abuts on the photosensitive member, an electric potential at the surface of the photosensitive member tends to be instable. It appears that this is because a far greater amount of toner than in an ordinary image forming operation is scraped off and the resultant electric charges tend to remain on the photosensitive member. Even when new toner is made adhere to the surface of the photosensitive member having such an instable potential, it is difficult to maintain the amount of adhering toner constant.

Of the toner-accumulating toner image, an area transferred from the photosensitive member onto the intermediate transfer member will be hereinafter referred to as a “first area” and an area left on the photosensitive member will be hereinafter referred to as a “second area”. In this instance, it is desirable to form the first area within a surface area in the surface of the photosensitive member which is different from an area in which the second area is formed during the immediately preceding rotation. The surface of the photosensitive member right after removal of a great amount of toner constituting the second area has an instable surface potential, and therefore, forming the first area outside such an area having an instable potential stabilizes the amount of toner fed to the intermediate transfer member.

It is also desirable to determine the respective sizes of the first area and the second area in accordance with the histories of use of the photosensitive member and the intermediate transfer member. This makes it possible to optimize the amounts of toner fed respectively to the abutting section between the photosensitive member and the photosensitive member cleaner and the abutting section between the intermediate transfer member and the intermediate transfer member cleaner.

The above and further objects and novel features of the invention will more fully appear from the following detailed description when the same is read in connection with the accompanying drawing. It is to be expressly understood, however, that the drawing is for purpose of illustration only and is not intended as a definition of the limits of the invention.

### BRIEF DESCRIPTION OF THE DRAWINGS

FIG. 1 is a drawing which shows an embodiment of the image forming apparatus according to the invention;

FIG. 2 is a block diagram of the electric structure of the image forming apparatus shown in FIG. 1;

FIGS. 3A and 3B are drawings which show the structure of the cleaner according to this embodiment;

FIG. 4 is a perspective view for describing the dimensions of the cleaner and the intermediate transfer belt;

FIG. 5 is an enlarged view of a section around the photosensitive member;

FIG. 6 is a flow chart of the first toner accumulating processing;

FIG. 7 is a flow chart of the new unit-triggered toner accumulating processing;

FIG. 8 is a drawing which shows a first example of the toner-accumulating patch image;

FIG. 9 is a timing chart of an operation of forming the patch image shown in FIG. 8;

FIG. 10 shows a second example of the toner-accumulating patch image;

FIG. 11 is a timing chart which shows the operation of forming the patch image shown in FIG. 10;

FIG. 12 is a drawing which shows a relationship between the timing of executing the toner accumulating processing and the length of the patch image;

FIG. 13 is a flow chart of the toner accumulating processing executed for every certain periods of time:

FIG. 14 is a first graph for determining the length of the patch image;

FIG. 15 is a second graph for determining the length of the patch image;

FIG. 16 is a flow chart of the toner accumulating processing executed based on the volume of rotations of the photosensitive member;

FIG. 17 is a third graph for determining the length of the patch image;

FIG. 18 is a drawing which shows the structure of an intermediate transfer belt;

FIG. 19 is a drawing which shows the surface of the intermediate transfer belt;

FIG. 20 is a flow chart of the operation immediately after power-on;

FIG. 21 is a drawing of a third example of the toner-accumulating patch image;

FIG. 22 is a drawing of a fourth example of the toner-accumulating patch image;

FIG. 23 is a flow chart of the condition controlling operation;

FIG. 24 is a drawing of a patch image during the condition controlling operation;

FIG. 25 is a drawing which shows other example of the structure of the intermediate transfer belt;

FIG. 26 is a perspective view for describing the dimensions of the cleaner and the intermediate transfer belt;

FIG. 27 is a drawing of the splice of the intermediate transfer belt;

FIGS. 28A and 28B are drawings for describing the lubrication effect of toner on a belt having a splice;

FIGS. 29 through 32 are drawings which show other examples of the shape of the splice of the belt;

FIGS. 33A and 33B are drawings which show modified toner stopper sheets;

FIGS. 34A through 34F are drawings which show examples of the cross sectional shape of the toner stopper sheet;

FIG. 35 is a drawing which shows other example of the structure of the cleaner;

FIGS. 36 and 37 are drawings which show still other example of the structure of the cleaner;

FIG. 38 is a drawing which shows an example of the link mechanism between the arm member and the top cover; and

FIG. 39 is a drawing which shows a further example of the cleaner.

### DESCRIPTION OF EXEMPLARY EMBODIMENTS

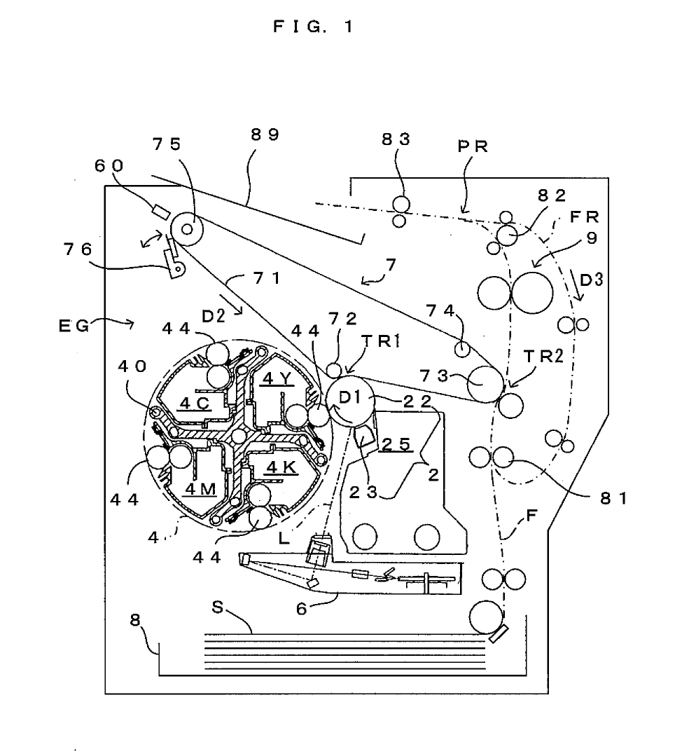

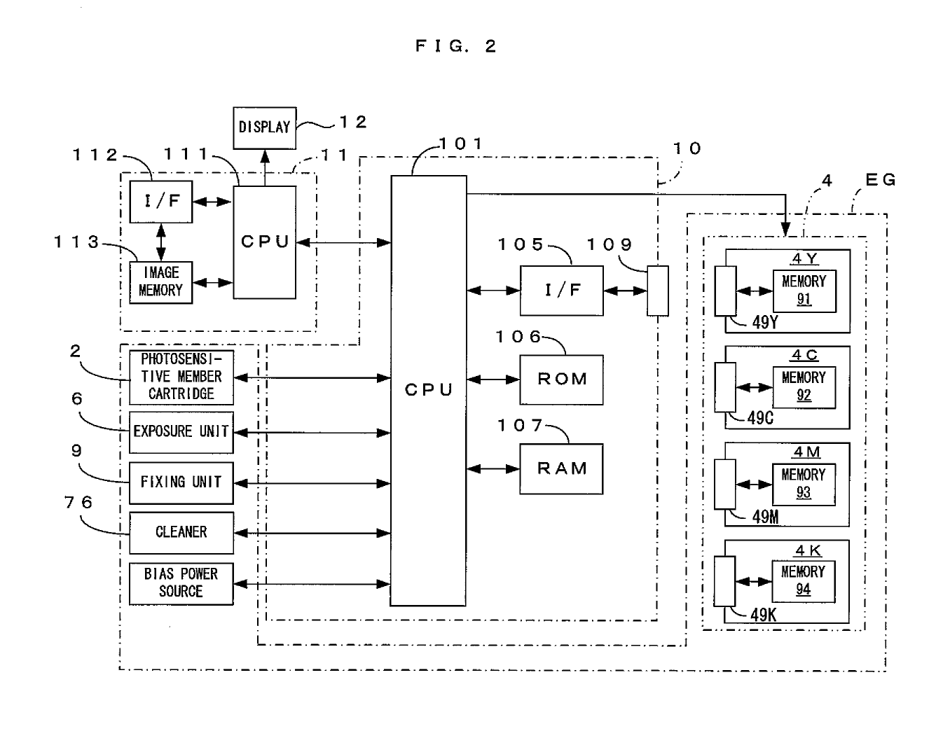

FIG. 1 is a drawing which shows an embodiment of the image forming apparatus according to the invention. FIG. 2 is a block diagram of the electric structure of the image forming apparatus shown in FIG. 1. The illustrated apparatus is an apparatus which overlays toner in four colors of yellow (Y), cyan (C), magenta (M) and black (K) one atop the other and accordingly forms a full-color image, or forms a monochrome image using only black toner (K). In the image forming apparatus, when an image signal is fed to a main controller 11 from an external apparatus such as a host computer, a predetermined image forming operation is performed by an engine controller 10, which controls respective portions of an engine part EG in accordance with an instruction received from the main controller 11, and an image which corresponds to the image signal is formed on a sheet S.

In the engine part EG, a photosensitive member 22 is disposed so that the photosensitive member 22 can freely rotate in the arrow direction D1 shown in FIG. 1. Around the photosensitive member 22, a charger unit 23, a rotary developer unit 4 and a cleaner 25 are disposed in the rotation direction D1. A predetermined charging bias is applied upon the charger unit 23, whereby an outer circumferential surface of the photosensitive member 22 is charged uniformly to a predetermined surface potential. The cleaner 25 removes toner which remains adhering to the surface of the photosensitive member 22 after primary transfer, and collects the toner into a used toner tank which is disposed inside the cleaner 25. The photosensitive member 22, the charger unit 23 and the cleaner 25, integrated as one, form a photosensitive member cartridge 2, and the photosensitive member cartridge 2 can be freely attached to and detached from a main section of the apparatus as one integrated unit.

An exposure unit 6 emits a light beam L toward the outer circumferential surface of the photosensitive member 22 which is thus charged by the charger unit 23. The exposure unit 6 makes the light beam L expose on the photosensitive member 22 in accordance with an image signal fed from the external apparatus and forms an electrostatic latent image which corresponds to the image signal.

The developer unit 4 develops thus formed electrostatic latent image with toner. That is, in the embodiment, the developer unit 4 comprises a support frame 40 which is disposed for free rotations about a rotation shaft which is perpendicular to the plane of FIG. 1, and also comprises a yellow developer 4Y, a cyan developer 4C, a magenta developer 4M and a black developer 4K which house toner of the respective colors and are formed as cartridges which are freely attachable to and detachable from the support frame 40. The engine controller 10 controls the developer unit 4. The developer unit 4 is driven into rotations based on a control instruction from the engine controller 10. When the developers 4Y, 4C, 4M and 4K are selectively positioned at a predetermined developing position which abuts on the photosensitive member 22 or is away a predetermined gap from the photosensitive member 22, toner of the color corresponding to the selected developer is supplied onto the surface of the photosensitive member 22 from a developer roller 44 disposed to the selected developer which carries toner of this color and has been applied with the predetermined developing bias. As a result, the electrostatic latent image on the photosensitive member 22 is visualized in the selected toner color.

A toner image developed by the developer unit 4 in the manner above is primarily transferred onto an intermediate transfer belt 71 of a transfer unit 7 in a primary transfer region TR1. The transfer unit 7 comprises the intermediate transfer belt 71 which runs across a plurality of rollers 72 through 75, and a driver (not shown) which drives a roller 73 into rotations to thereby rotate the intermediate transfer belt 71 along a predetermined rotation direction D2. For transfer of a color image on the sheet S, toner images in the respective colors on the photosensitive member 22 are superposed one atop the other on the intermediate transfer belt 71, thereby forming a color image. Further, on the sheet S unloaded from a cassette 8 one at a time and transported to a secondary transfer region TR2 along a transportation path F, the color image is secondarily transferred.

At this stage, for the purpose of properly transfer the image on the intermediate transfer belt 71 onto the sheet S at a predetermined position, the timing of feeding the sheet S to the secondary transfer region TR2 is managed. Describing this in more specific details, there is a gate roller 81 before the secondary transfer region TR2 on the transportation path F. As the gate roller 81 rotates timed to the rotations of the intermediate transfer belt 71, the sheet S is fed to the secondary transfer region TR2.

A fixing unit 9 fixes the toner image now borne by the sheet S, and the sheet S is transported to a discharge tray part 89, which is attached to the top surface of the main apparatus section, via a pre-discharge roller 82 and a discharge roller 83. In the event that images are to be formed on the both surfaces of the sheet S, the discharge roller 83 start rotating in the reverse direction upon arrival of the rear end of the sheet S, which carries an image on its one surface as described above, at a reversing position PR behind the pre-discharge roller 82, thereby transporting the sheet S in the arrow direction D3 along a reverse transportation path FR. While the sheet S is returned back to the transportation path F again before arriving at the gate roller 81, the surface of the sheet S which abuts on the intermediate transfer belt 71 in the secondary transfer region TR2 and is to receive a transferred image is at this stage is opposite to the surface which already bears the earlier image. In this fashion, it is possible to form images on the both surfaces of the sheet S.

Further, there is a cleaner 76 in the vicinity of the roller 75. The cleaner 76 can freely abut on and move away from the roller 75, owing to an electromagnetic clutch not shown. In a condition that the cleaner 76 has moved to the roller 75, the blade of the cleaner 76 abuts on the surface of the intermediate transfer belt 71 spanning around the roller 75 and removes toner which remains adhering to the outer circumferential surface of the intermediate transfer belt 71 even after the secondary transfer.

During image transfer onto the sheet S within the secondary transfer region TR2, the cleaner 76 is controlled to abut on and move away from the intermediate transfer belt 71 for removal of toner remaining on the intermediate transfer belt 71 during the same belt revolution as that for the image transfer. Hence, for the apparatus to continuously form monochrome images for instance, as an image transferred onto the intermediate transfer belt 71 within the primary transfer region TR1 gets immediately transferred onto the sheet S within the secondary transfer region TR2, the cleaner 76 remains abutting on the belt. In the meantime, to form a color image, the cleaner 76 needs stay away from the intermediate transfer belt 71 while toner images in the respective colors are being superimposed one atop the other. In the same belt revolution during which the toner images in the respective colors are superimposed one atop the other and a resulting full-color image is secondarily transferred onto the sheet S, the cleaner 76 abuts on the intermediate transfer belt 71 to remove the remaining toner. The structure and the operation of the cleaner 76 will be described in detail later

Further, there is a density sensor 60 in the vicinity of the roller 75. The density sensor 60 is disposed facing the surface of the intermediate transfer belt 71, and measures the image density of a toner image formed on the outer circumferential surface of the intermediate transfer belt 71 when needed. This apparatus adjusts the operating conditions for the respective portions of the apparatus which influence the quality of an image, such as a developing bias applied upon each developer and the intensity of the light beam L, based on the measurement result. The density sensor 60 is structured so as to output, using a reflection-type photosensor for example, a signal which corresponds to the image density in an area having a predetermined size on the intermediate transfer belt 71. Rotating the intermediate transfer belt 71 and regularly sampling the output signal from the density sensor 60, the CPU 101 detects the image densities of the respective parts of a toner image on the intermediate transfer belt 71.

Further, as shown in FIG. 2, the developers 4Y, 4C, 4M and 4K respectively mount memories 91 through 94 which store data regarding the production batches and the usage histories, the remaining toner amounts and the like of the associated developers. Wireless communication units 49Y, 49C, 49M and 49K are additionally disposed to the developers 4Y, 4C, 4M and 4K. When needed, these units selectively establish non-contact data telecommunications with a wireless communication unit 109 which is disposed to the main apparatus section and data are transferred between the CPU 101 and the respective memories 91 through 94 via the interface 105, thereby managing various types of information regarding the developers such as information on management of consumables. Although non-contact data transfer is done through wireless telecommunications which are established electro-magnetically according to this embodiment, connectors or the like may be disposed to the main apparatus section and the respective developers and the main apparatus section and the respective developers may transfer data with each other as the connectors or the like are mechanically fit to each other.

In addition, this apparatus comprises a display 12 which a CPU 111 of the main controller 11 controls, as shown in FIG. 2. The display 12 is formed by a liquid crystal display for instance, and in response to a control command from the CPU 111, shows predetermined messages to inform a user of operation guidance, the progress of the image forming operation, the occurrence of abnormality in the apparatus, the timing of exchange any unit, etc.

In FIG. 2, denoted at 113 is an image memory which is disposed to the main controller 11 to store an image fed through the interface 112 from an external apparatus such as a host computer. Denoted at 106 is a ROM which stores a calculation program executed by the CPU 101, control data for control of the engine part EG, etc. Denoted at 107 is a RAM which temporarily stores a calculation result derived by the CPU 101, other data, etc.

This image forming apparatus is used as it mounts the four developers which hold toner of the mutually different colors as described above, but when one developer or multiple developers holding toner of the same color are mounted, the apparatus is used as an image forming apparatus dedicated to a monochrome image. In short, this image forming apparatus, when mounting only one developer, operates as an apparatus which forms a monochrome image of the corresponding toner color. Further, when mounting multiple developers holding toner of the same color, this image forming apparatus operates as an apparatus which forms monochrome images of that toner color using one of the developers or while appropriately changing the developers.

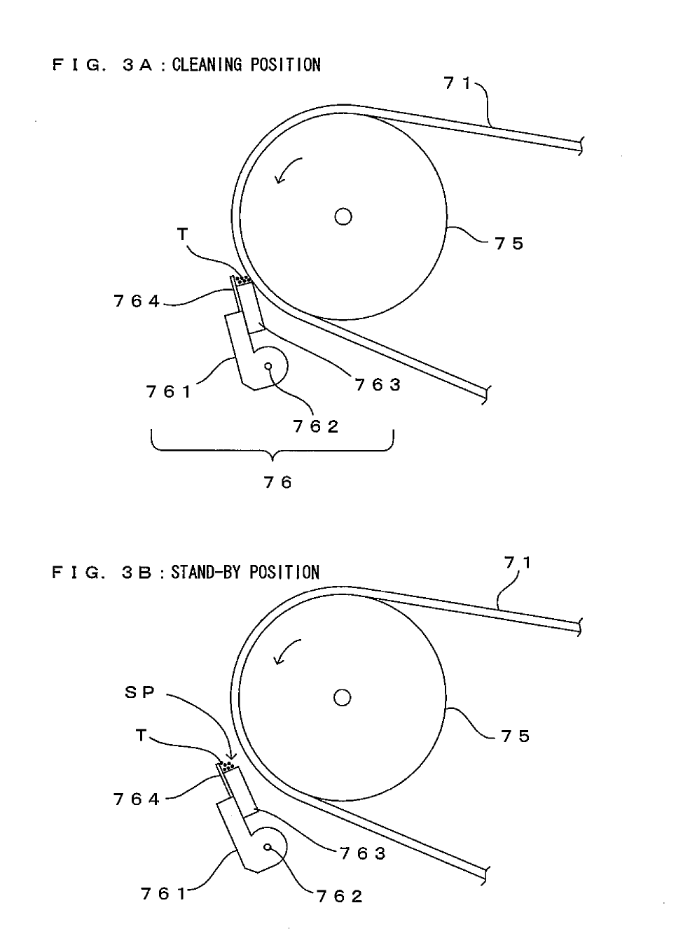

FIGS. 3A and 3B are drawings which show the structure of the cleaner according to this embodiment. As shown in FIG. 3A, in the cleaner 76, a blade 763 which contacts the intermediate transfer belt 71 and scrapes off toner is attached to an arm member 761 which is capable of freely revolving about a rotation axis 762. The blade 763 is made of an elastic material which may be urethane rubber for example, and shaped like a plate which extends along the width direction which is orthogonal to the travel direction in which the intermediate transfer belt 71 moves (i.e., the direction orthogonal to the plane of FIG. 3A). There is a toner stopper sheet 764 at the edge and opposite surface of the blade 763 which is opposed against the roller 75. The toner stopper sheet 764 is a sheet-like member of resin with which the blade 763 is lined.

The cleaner 76 having this structure revolves about the rotation axis 762 when driven by a drive mechanism not shown. The blade 763 is therefore switched between its state that it abuts on the intermediate transfer belt 71 (FIG. 3A) and its state that it stays away from the intermediate transfer belt 71 (FIG. 3B). Describing this in more specific details, as the rotation axis 762 is driven in the clockwise direction in FIGS. 3A and 3B when the cleaner 76 is at its stand-by position (FIG. 3B) where the blade 763 is off the intermediate transfer belt 71, the tip of the blade 763 moves from the left-hand side to the right-hand side in FIGS. 3A and 3B and contacts the intermediate transfer belt 71 (cleaning position, FIG. 3A). In this instance, the tip of the blade moves approximately horizontally.

While abutting on the intermediate transfer belt 71, the blade 763 scrapes off toner which adheres on the intermediate transfer belt 71. Thus scraped-off toner T builds up within a space which is enclosed by the intermediate transfer belt 71, the blade 763 and the toner stopper sheet 764 on the upstream side to an abutting section of the intermediate transfer belt 71 and the blade 763 along the transportation direction of the intermediate transfer belt 71, as shown in FIG. 3A. The accumulated toner T functions as a lubricant in the abutting section where the intermediate transfer belt 71 and the blade 763 abut on each other and reduces frictional resistance between the intermediate transfer belt 71 and the blade 763, which obviates wear of the intermediate transfer belt 71 and prevents the ends of the blade 763 from getting lapped.

On the contrary, the blade 763 moves away from the intermediate transfer belt 71 when the cleaner 76 moves to its stand-by position. As this occurs, the toner T accumulated near the tip of the blade 763 will fall off from the blade 763 but for the toner stopper sheet. In this embodiment however, since there is the toner stopper sheet 764, the toner will not drop but stay in a space SP between the blade 763 and the toner stopper sheet 764 (toner reservoir space) as shown in FIG. 3B.

As described above, according to this embodiment, even when the blade 763 is away from the intermediate transfer belt 71, a certain amount of toner remains accumulated in the vicinity of the tip of the blade 763. Hence, as the blade 763 moves toward the intermediate transfer belt 71 again, abuts on the surface of the intermediate transfer belt 71 and stops moving, the resulting recoil feeds the toner T which used to stay in the toner reservoir space SP into this abutting section or to an upstream area relative to the abutting section along the travel direction in which the intermediate transfer belt 71 moves. This lubrication effect of the toner significantly reduces wear of the intermediate transfer belt 71 and prevents the ends of the blade 763 from getting lapped.

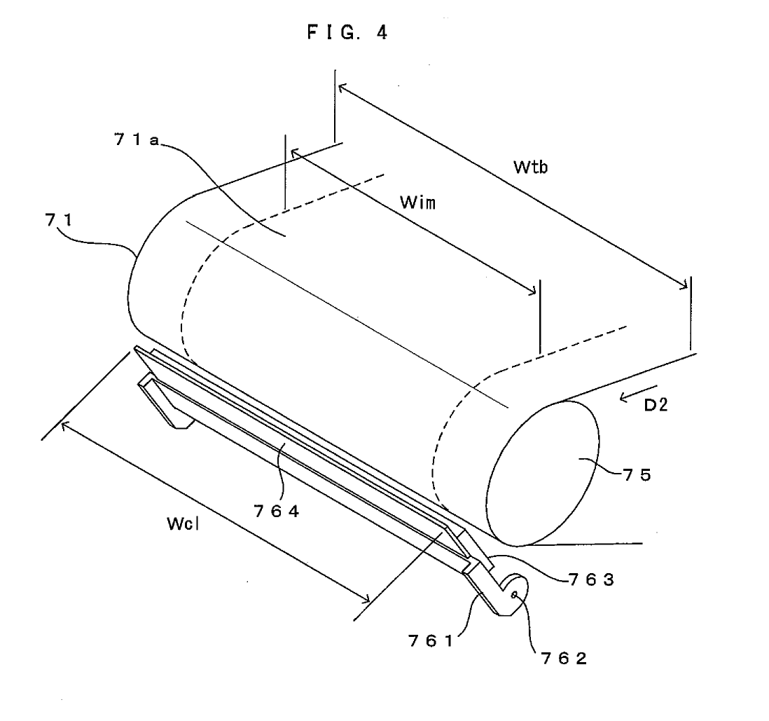

FIG. 4 is a perspective view for describing the dimensions of the cleaner and the intermediate transfer belt. The intermediate transfer belt 71 does not bear an image all along its width. An image is formed only in a predetermined image forming region (the region between the two dotted lines in FIG. 4) 71a which corresponds to the size of the sheet S. The width of the blade 763 of the cleaner 76 is set to be wider than the width of the image forming region 71a but narrower than the width of the intermediate transfer belt 71. That is, where the symbol Wtb denotes the width of the intermediate transfer belt 71, the symbol Wim denotes the width of the image forming region on the intermediate transfer belt 71 and the symbol Wc1 denotes the width of the blade 763, the widths satisfy the following relationship:
Wtb>Wc1>Wim

As the width Wc1 of the blade 763 is wider than the width Wim of the image forming region 71a, it is possible to remove toner adhering inside the image forming region and a surrounding area without fail, and therefore, prevent a next image from getting smeared. The excessively wide width of the blade 763 however, e.g., the width as wide as the width Wtb of the intermediate transfer belt 71 could backfire. That is, the blade 763 abutting on the intermediate transfer belt 71 serves as a load upon a motor (not shown) which drives the belt 71 into rotations, and further, since the blade 763 abuts on and moves away from the intermediate transfer belt 71, the blade 763 could vary the rotation speed of the intermediate transfer belt 71. Further, toner failing to get transferred to the sheet S in the secondary transfer region TR2 during the image forming operation will remain within the image forming region 71a, and this toner will serve as a lubricant when scraped off by the blade 763. On the contrary, there is only a very small amount of such toner present outside the image forming region 71a, friction between the intermediate transfer belt 71 and the blade 763 intensifies outside the image forming region 71a, and the intermediate transfer belt 71 and the blade 763 therefore can easily get worn or damaged in this area. Noting this, the width Wc1 of the blade 763 is ideally as narrow as possible but needs be wider than the width of the image forming region 71a.

In the event that the apparatus is capable of handling multiple types of sheets whose sizes are different, the width of the blade 763 may be wider than the width of the image forming region which corresponds to the widest sheets.

The width of the toner stopper sheet will now be considered. The problems such as wear of the intermediate transfer belt 71 and the lapped ends of the blade 763 owing to friction between the intermediate transfer belt 71 and the blade 763 can occur all over the area where the two are in contact. Hence, the toner stopper sheet 764 which suppresses this preferably spans all along the width of the blade 763. In short, the width of the toner stopper sheet 764 is preferably equal to or wider than the width Wc1 of the blade 763. The toner stopper sheet 764 may stretch even beyond the blade 763.

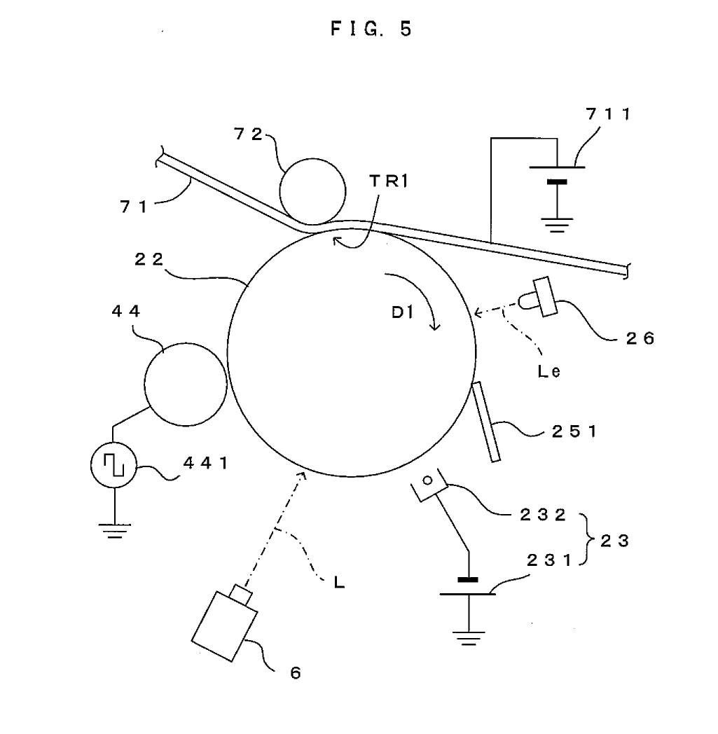

FIG. 5 is an enlarged view of a section around the photosensitive member. The photosensitive member 22 rotates at a constant speed in a rotation direction D1 shown in FIG. 5. A corona charger 232 upon which a predetermined charging bias 231 is applied charges up the surface of the photosensitive member 22 to a certain surface potential. The exposure unit 6 irradiates thus charged surface of the photosensitive member 22 with the exposure light beam L, thereby forming an electrostatic latent image. The developing roller 44 upon which a predetermined developing bias 441 is applied then supplies toner to the surface of the photosensitive member, and the electrostatic latent image is visualized as a toner image.

The toner image is primarily transferred onto the surface of the intermediate transfer belt 71 within the primary transfer region TR1. Although not shown, the intermediate transfer belt 71 has a conductive layer formed by a metal foil or a vapor-deposited metal film and a resistive surface layer made of a material whose specific resistance is greater than that of the conductive layer, and a predetermined primary transfer bias 711 is applied upon the conductive layer. Application of the primary transfer bias having the opposite polarity to the polarity of toner causes toner on the photosensitive member 22 to move toward the intermediate transfer belt 71 because of static electricity. Meanwhile, as the primary transfer bias is turned off or changed to the same polarity as the polarity of toner, movement of toner from the photosensitive member 22 to the intermediate transfer belt 71 is not facilitated. In short, in this apparatus, appropriate control of the primary transfer bias 711 makes it possible to select whether to transfer a toner image from the photosensitive member 22 to the intermediate transfer belt 71.

On the downstream side to the primary transfer region TR1 along the rotation direction D1 of the intermediate transfer belt 71, irradiated light Le from a discharging light source 26 falls upon the surface of the photosensitive member 22, which neutralizes the electric charges remaining on the surface of the photosensitive member 22 and accordingly discharges the surface of the photosensitive member 22. On the further downstream side, a cleaner blade 251 of the cleaner 25 (FIG. 1) is disposed so as to abut on the surface of the photosensitive member 22, and removes toner remaining on the surface of the photosensitive member 22. The corona charger 232 thereafter charges up the photosensitive member 22 again and the photosensitive member 22 is made ready to form the next image. The blade 251 stays always abutting on the photosensitive member 22, instead of moving away from and abutting on the photosensitive member.

The toner accumulating processing in the image forming apparatus having such a structure will now be described. The toner accumulating processing is processing for feeding toner to each one of the abutting section where the photosensitive member 22 and the cleaner blade 251 abut on each other and the abutting section where the intermediate transfer belt 71 and the cleaner blade 763 abut on each other and making the toner accumulating in each abutting section function as a lubricant. The CPU 101 of the engine controller 10 executes the toner accumulating processing in accordance with a program stored in advance in the ROM 106. In this image forming apparatus, at the time of power-on of the apparatus, it is first toner accumulating processing that is executed if either one of the photosensitive member cartridge 2 and the transfer unit 7 is found to be new after replaced. Second toner accumulating processing is executed when a predetermined processing start condition is met while the apparatus is in its operation. The first toner accumulating processing and the second toner accumulating processing will be performed in different manners as described below.

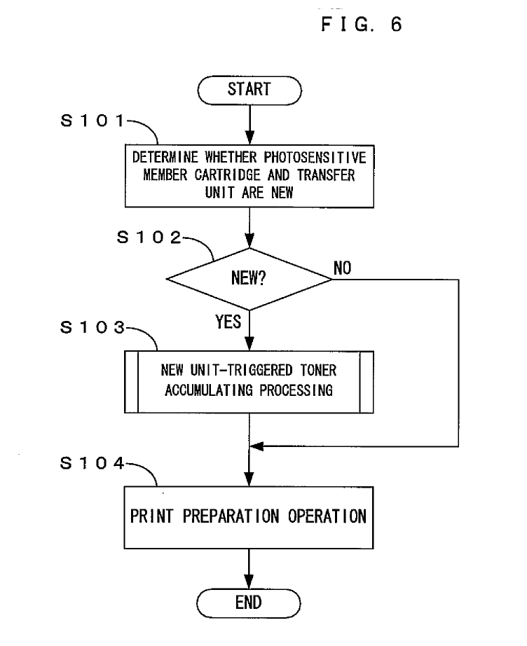

FIG. 6 is a flow chart of the first toner accumulating processing. This processing is executed immediately after power-on of the apparatus. As the apparatus is powered on, first, the CPU 101 determines whether the photosensitive member cartridge 2 and the transfer unit 7 are new (Step S101). When at least one of the photosensitive member cartridge 2 and the transfer unit 7 is new (Step S102), new unit-triggered toner accumulating processing described later (Step S103) and a print preparation operation (Step S104) are carried out one after another, whereas when neither is new, the print preparation operation alone is executed, skipping the toner accumulating processing. The print preparation operation is processing which is necessary to shift the apparatus as it is right after power-on to a state in which the apparatus can execute the image forming operation, and includes confirmation of the states of the mounted developers, control of the image forming conditions, warm-up of the fixing unit 9, etc. The contents of these processing are known and therefore will not be described.

Whether the photosensitive member cartridge 2 and the transfer unit 7 are new can be determined in the following manner, for example. Fuses (not shown) are disposed to the photosensitive member cartridge 2 and the transfer unit 7, and a current source (not shown), which can supply a sufficient current to blow the fuses, is disposed to the main apparatus section. As the apparatus is powered on with a new photosensitive member cartridge 2 or a new transfer unit 7 mounted, the current flows from the current source to the corresponding fuse. On the contrary, if neither unit is new, the fuses are already dead and will not carry the current. In other words, depending upon whether the fuses carry the current upon power-on, it is possible to determine if the photosensitive member cartridge 2 and the transfer unit 7 are new. Other than this approach, a memory may be disposed which stores information regarding the serial numbers, the use histories or the like, and whether these units are new may be determined from this information.

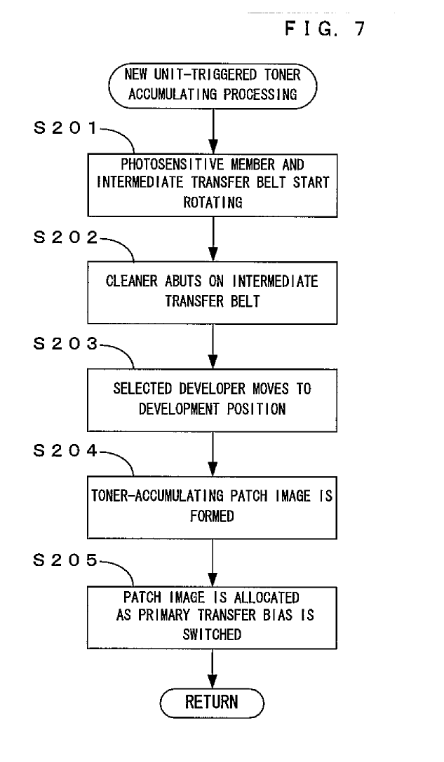

FIG. 7 is a flow chart of the new unit-triggered toner accumulating processing. During this toner accumulating processing, the photosensitive member 22 and the intermediate transfer belt 71 start rotating (Step S201), followed by driving of the cleaner 76 and abutting of the blade 763 on the intermediate transfer belt 71 (Step S202). Next, one developer (which may be the black developer 4K for example) chosen in accordance with an appropriate criterion from among the developers mounted to the developing unit 4 moves to a development position which is opposed against the photosensitive member 22 (Step S203). Following this, a toner-accumulating patch image described next is formed (Step S204). As described later, thus formed patch image is allocated to the photosensitive member 22 and the intermediate transfer belt 71, as the primary transfer bias is switched.

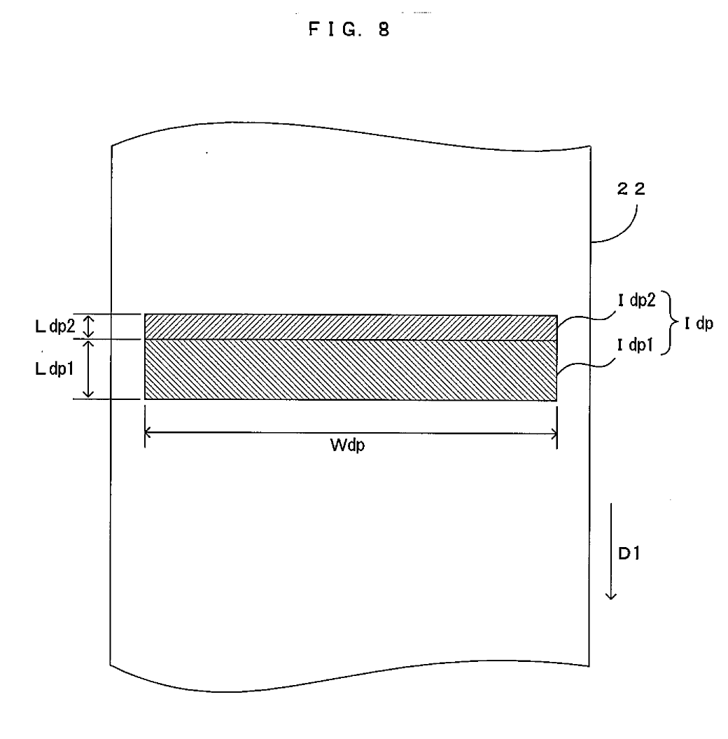

FIG. 8 is a drawing which shows a first example of the toner-accumulating patch image. The illustrated toner-accumulating patch image Idp is a strip-like image extending along the direction which is orthogonal to the travel direction D1 in which the photosensitive member 22 moves. Although the image pattern of the toner-accumulating patch image may be any desired pattern, the toner-accumulating patch image is preferably a solid image as it is easy to form a solid image. The toner-accumulating patch image Idp is formed by a part image Idp1 having the length Ldp1 along the travel direction D1 of the photosensitive member 22 and a part image Idp2 having the length Ldp2 along this direction. The reason of this will be described later. However, these image parts have the same image pattern, and therefore, there is no clear boundary between the two. In essence, the toner-accumulating patch image Idp is a solid image having the length (Ldp1+Ldp2) in the travel direction D1 of the photosensitive member 22 and having the width Wdp. The width Wdp of the toner-accumulating patch image Idp is wider than the width Wim of the image forming region on the intermediate transfer belt 71, but is narrower than the width Wc1 of the cleaner blade 763 which abuts on the intermediate transfer belt 71. The width of the developing roller 44 along the direction which is orthogonal to the travel direction D1 of the photosensitive member 22 is preferably somewhat narrower than the blade width Wc1 to thereby form the toner-accumulating patch image Idp all along the width of the developing roller 44.

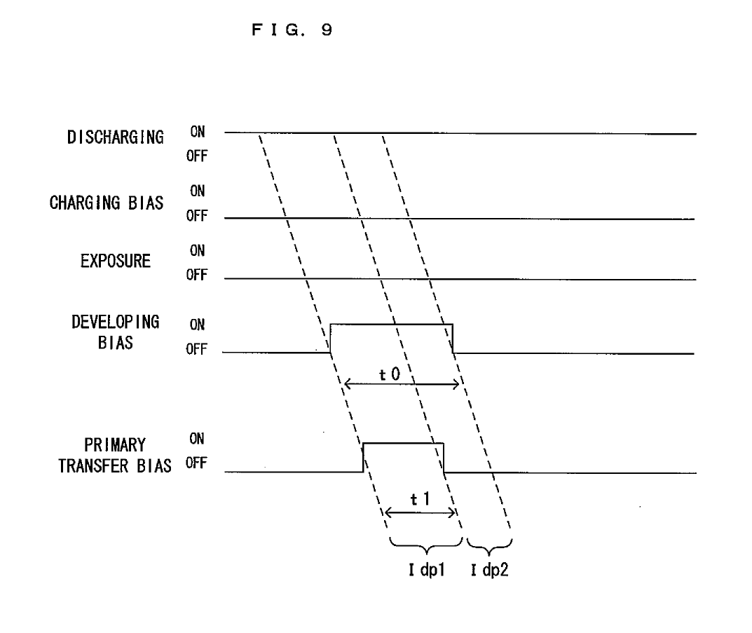

FIG. 9 is a timing chart of an operation of forming the patch image shown in FIG. 8. As described above, where the width Wdp of the toner-accumulating patch image Idp is set to the width of the developing roller 44 and the image pattern of the toner-accumulating patch image is set to a solid image, it is possible to form this patch image in the following manner even without execution of the ordinary image forming process. First, the discharging light source 26 is left always turned on, whereas the charging bias and the exposure beam are kept always off. In this condition, although discharged, the surface of the photosensitive member 22 will not newly charged up, and hence, the surface potential of the photosensitive member is about the residual potential unique to the material of the photosensitive member. The residual potential is a close value to the surface potential within an exposed section (an area exposed with the light beam L after charged up to a predetermined potential) during the ordinary image forming operation. In other words, through the process above, the surface of the photosensitive member 22 has an electric potential profile which is similar to that obtained by exposing the entire surface of the photosensitive member.

Only for a predetermined period of time to, the developing bias is applied upon the developing roller 44 which is opposed against the photosensitive member 22 having such an electric potential profile. In consequence, on the photosensitive member 22, a solid image is formed whose width corresponds to the width of the developing roller 44 and whose length corresponds to the duration of application of the developing bias. In this embodiment, application of the developing bias upon the developing roller 44 for the predetermined period while keeping with the discharging light source turned on but the charging bias and the exposure beam turned off thus forms the toner-accumulating patch image Idp on the photosensitive member 22. Of course, the toner-accumulating patch image Idp may be formed by the ordinary image forming process which utilizes charging and exposure.

Out of a period of time during which the toner-accumulating patch image Idp formed on the photosensitive member 22 in this manner moves passed the primary transfer region TR1, only during a shorter period t1 than the above period to, the primary transfer bias 711 is applied upon the intermediate transfer belt 71. Although the toner image moving passed the primary transfer region TR1 while being applied with the primary transfer bias is transferred onto the intermediate transfer belt 71, the toner image moving passed the primary transfer region TR1 not subjected to application of the primary transfer bias is not transferred onto the intermediate transfer belt 71 but remains on the photosensitive member 22. In other words, in this embodiment, a part of the patch image on the photosensitive member 22 is allocated to the intermediate transfer belt 71 and another part of the patch image is allocated to the photosensitive member 22, as the primary transfer bias is switched.

Of the period of time during which the patch image Idp moves passed the primary transfer region TR1, the period t1 during which the primary transfer bias is applied is a period of time during which the length Ldp1 from the front edge of the patch image Idp moves passed the primary transfer region TR1. This ensures transfer of the image part Idp1 having the length Ldp1 among the image parts which form the toner-accumulating patch image Idp onto the intermediate transfer belt 71, but allows the image part Idp2 having the length Ldp2 move passed the primary transfer region TR1 while remaining on the photosensitive member 22.

The image part Idp1 transferred onto the intermediate transfer belt 71 is transported to the downward side, as the intermediate transfer belt 71 rotates. During this, it is secured that secondary transfer in the secondary transfer region TR2 does not take place: a secondary transfer bias supplied to the secondary transfer region TR2 is turned off or the secondary transfer roller is maintained away from the intermediate transfer belt 71, to thereby eventually scrape off the image part Idp1 with the cleaner blade 763. As a result, toner builds up in the toner reservoir space SP (FIG. 3) which is at the tip of the blade.

Meanwhile, the image part Idp2 of the toner-accumulating patch image Idp left on the photosensitive member 22 is transported to the downstream side as the photosensitive member 22 rotates, and eventually scraped off by the blade 251. Toner therefore builds up in the abutting section where the photosensitive member 22 and the cleaner blade 251 abut on each other. Since the blade 251 remains abutting on the photosensitive member 22, it is less likely that the accumulated toner will fall off as compared to the toner on the cleaner 76 which moves away and abuts on the intermediate transfer belt 71. For this reason, the cleaner blade 251 abutting on the photosensitive member 22 does not have a toner stopper sheet.

As described above, this embodiment requires executing the toner accumulating processing when either one of the photosensitive member cartridge 2 or the transfer unit 7 is new. During the toner accumulating processing, the toner-accumulating patch image Idp shaped like a strip is formed, and as the primary transfer bias is switched, only the image part Idp1 corresponding to the length Ldp1 out of the toner-accumulating patch image Idp is transferred onto the intermediate transfer belt 71. Of the toner constituting the toner-accumulating patch image Idp, some portion is fed into the abutting section between the intermediate transfer belt 71 and the blade 763, and the remaining portion is fed into the abutting section between the photosensitive member 22 and the blade 251. The toner builds up at the tip of each blade and acts as a lubricant. In this embodiment, the toner constituting the toner-accumulating patch image Idp which is formed through one operation is allocated to the photosensitive member 22 and the intermediate transfer belt 71, which realizes the toner accumulating processing efficiently in a short period of time.

The toner-accumulating patch image Idp shown in FIG. 8 is formed on the photosensitive member 22 such that the image part Idp1 is located ahead of the image part Idp2 along the travel direction D1 of the photosensitive member 22, i.e., formed before the image part Idp2 is formed on the photosensitive member 22. The reason of this is as described below.

As one can tell from in FIG. 5, the image part Idp2 left on the photosensitive member 22 moves passed the primary transfer region TR1 and her travels toward the downstream side as the photosensitive member 22 rotates, and scraped off by the blade 251 after irradiated with the irradiated light Le emitted from the discharging light source 26. At a discharging position where the irradiated light Le from the discharging light source 26 falls, the surface of the photosensitive member 22 still carries the image part Idp2. Therefore, a sufficient amount of the irradiated light Le may not reach the surface of the photosensitive member 22 and discharging may become insufficient. Further, the toner carried on the surface itself has electric charges. Hence, the surface potential of the photosensitive member 22 after moving passed the blade 251 tends to be instable.

When one tries forming a toner image in an area on the photosensitive member where the surface potential is instable, the disturbed electric potential profile of the photosensitive member greatly varies the amount of toner adhering to the photosensitive member. This problem is particularly serious in this embodiment, as this embodiment requires forming the toner-accumulating patch image while keeping the charging bias and the exposure beam turned off. If the toner-accumulating patch image is formed in such a surface area of the photosensitive member, a problem will arise that the amount of toner supplied to the abutting section between the photosensitive member 22 and the associated blade or the abutting section between the intermediate transfer belt 71 and the associated blade becomes instable.

Noting this, requiring forming the image part Idp1 to be allocated to the intermediate transfer belt 71 before forming the image part Idp2 to be allocated to the photosensitive member 22, this embodiment obviates such a problem. The surface area of the photosensitive member 22 corresponding to the image part Idp1 arrives at the discharging position with almost all adhering toner transferred onto the intermediate transfer belt 71. Hence, discharging failure will not occur, and if the next image, i.e., the image part Idp2 is formed in the subsequent area, no problem will occur.

For the same reason, it is desirable that the length Ldp2 of the image part Idp2 to be allocated to the photosensitive member 22 does not exceed the circumference of the photosensitive member 22. This is because if the image part Idp2 is longer than the circumference of the photosensitive member 22, the surface potential will become instable in an area corresponding to the start of the second rotation of the photosensitive member 22 as viewed from the front edge of the photosensitive member 22. Further, from the same perspective, the toner-accumulating patch image as that described below may be formed.

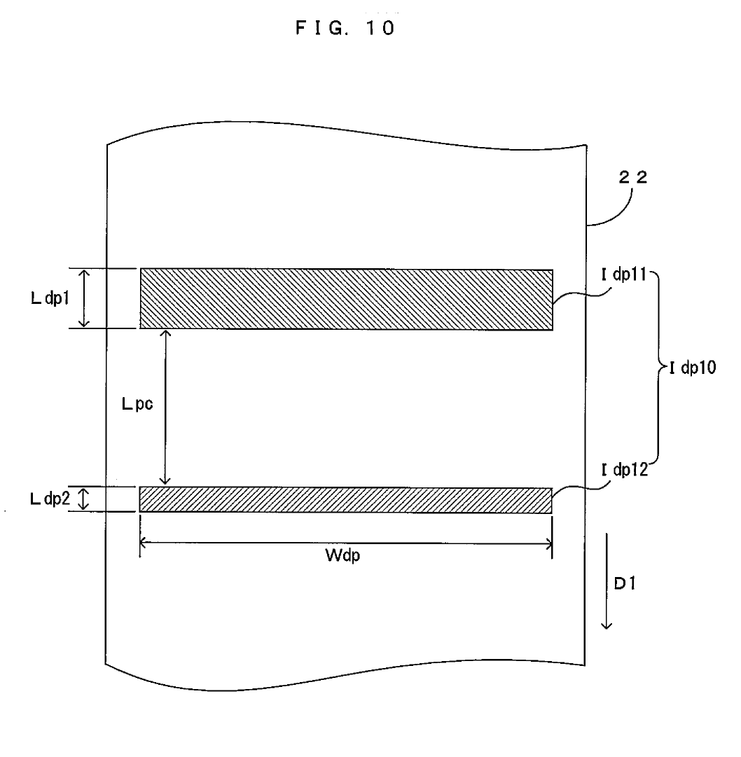

FIG. 10 shows a second example of the toner-accumulating patch image. In this example, of the illustrated toner-accumulating patch image Idp10, an image part Idp12 to be allocated to the photosensitive member 22 is formed before an image part Idp11 to be allocated to the intermediate transfer belt 71 is formed. However, the image part Idp11 and the image part Idp12 are formed apart from each other by at least a gap which is equal to or longer than the circumference Lpc of the photosensitive member along the travel direction D1 of the photosensitive member 22. This gap which is equal to or longer than the circumference Lpc of the photosensitive member ensures that the image part Idp1 is formed in an appropriately discharged area which is exclusive of an area on the photosensitive member 22 where the surface potential is disturbed, that is, exclusive of the area which used to carry the image part Idp12 during the immediately precedent rotation. This avoids a situation that the amount of toner does not stay constant.

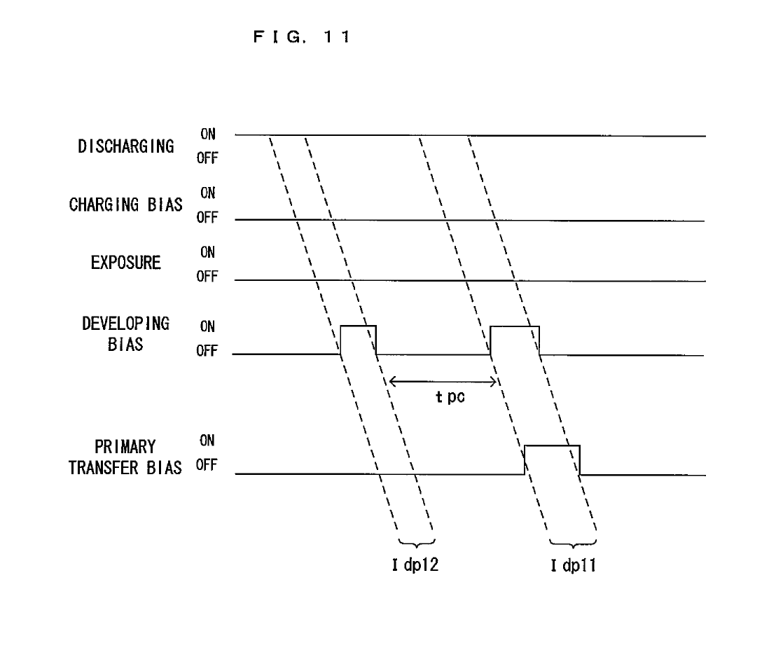

FIG. 11 is a timing chart which shows the operation of forming the patch image shown in FIG. 10. It is possible to form a toner-accumulating patch image as that shown in FIG. 10 by providing twice the ON-period of the developing bias which are apart by a time gap equal to or longer than the rotation cycle Tpc of the photosensitive member 22 as shown in FIG. 11. As the primary transfer bias is turned on only during one of these ON-periods, the image part Idp11 and the image part Idp12 are allocated to the photosensitive member 22 and the intermediate transfer belt 71, respectively.

The toner accumulating processing performed while the apparatus is in its operation will now be described. When the photosensitive member cartridge 2 and/or the transfer unit 7 is new, the toner accumulating processing is performed as described above. Toner accordingly accumulating however will be gradually lost as the apparatus keeps operating, which means that the accumulated amount does not always stay constant. As for the blade 763 which abuts on the intermediate transfer belt 71 in particular, toner is easily lost as the cleaner 76 abuts on and moves away from the intermediate transfer belt 71. In light of this, the toner accumulating processing is performed at proper timing for the sake of replenishing accumulated toner even during the operation of the apparatus. During the toner accumulating processing for this purpose however, the length of the toner-accumulating patch image along the travel direction D1 of the photosensitive member 22 is changed properly in accordance with the use histories of the apparatus, because the amount of accumulated toner varies depending upon the status of operation of the apparatus. The use histories in this context specifically express to what extent the photosensitive member 22 and the intermediate transfer belt 71 have worked so far. While the following will describe an example of forming the image Idp shown in FIG. 8 as the toner-accumulating patch image, the basic concept remains the same as that for where the image shown in FIG. 10 is to be formed.

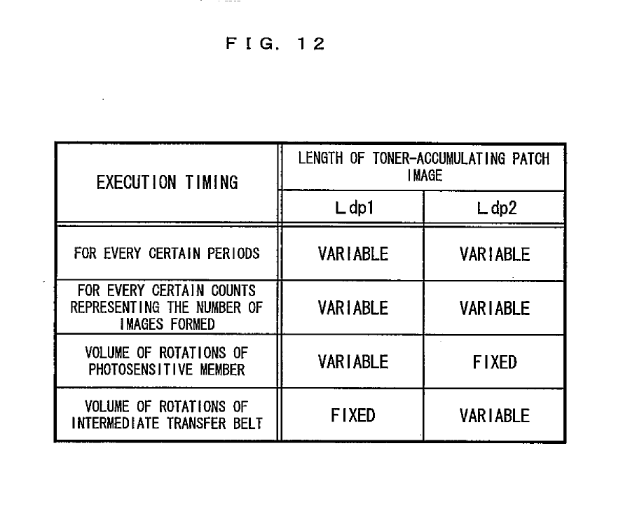

FIG. 12 is a drawing which shows a relationship between the timing of executing the toner accumulating processing and the length of the patch image. As the first column of the table in FIG. 12 shows as an example, the timing of executing the toner accumulating processing may be (1) for every certain periods of time, (2) for every certain counts representing the number of images formed, (3) every time the volume of rotations of the photosensitive member 22 reaches a certain value, (4) every time the volume of rotations of the intermediate transfer belt 71 reaches a certain value, etc.

Of these, in the event that the toner accumulating processing is executed for every certain periods of time, the amounts of operations of the photosensitive member 22 and the intermediate transfer belt 71 since execution of the previous toner accumulating processing up to the present time are not constant. Hence, the amounts of toner accumulating at the tips of the associated blades (251 and 763) as well are not constant. In this instance therefore, both the length Ldp1 of the image part Idp1 to be allocated to the intermediate transfer belt 71 and the length Ldp2 of the image part Idp2 to be allocated to the photosensitive member 22 are variable.

The above is equally applied to where the toner accumulating processing is executed for every certain counts representing the number of images formed. This is because the volume of rotations of the photosensitive member 22 for forming one image is different depending upon the size of the image to form, and the volume of rotations of the intermediate transfer belt 71 significantly changes depending upon whether the image to form is a color image or a monochrome image.

In the event that the toner accumulating processing is executed every time the volume of rotations of the photosensitive member 22 reaches a certain value, the volume of rotations of the photosensitive member 22 remains constant since execution of the previous toner accumulating processing up to the present time. This permits fixing the length Ldp2 of the image part Idp2 to be allocated to the photosensitive member 22. On the other hand, the length Ldp1 of the image part Idp1 to be allocated to the intermediate transfer belt 71 needs be variable. Where the toner accumulating processing is executed every time the volume of rotations of the intermediate transfer belt 71 reaches a certain value on the contrary, the length Ldp1 of the image part Idp1 to be allocated to the intermediate transfer belt 71 may be a fixed value. Meanwhile, since the volume of rotations of the photosensitive member 22 during this is not constant, the length Ldp2 of the image part Idp2 to be allocated to the photosensitive member 22 needs be variable.

(1) Toner accumulating processing for every certain periods of time

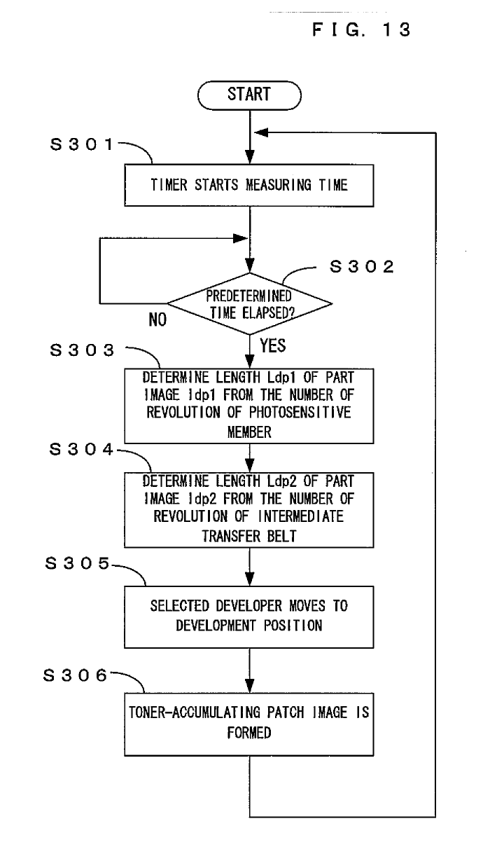

FIG. 13 is a flow chart of the toner accumulating processing executed for every certain periods of time. In this processing, as the apparatus is powered on and made ready for the image forming operation, an internal timer (not shown) disposed in the engine controller 10 starts measuring the time (Step S301). As a predetermined period of time elapses (Step S302), the length Ldp2 of the image part Idp2 is calculated from the integrated value of the number of revolution of the photosensitive member 22 since execution of the previous toner accumulating processing up to the present time (Step S303). In addition, the length Ldp1 of the image part Idp1 is calculated from the integrated value of the number of revolution of the intermediate transfer belt 71 during the same period (Step S304).

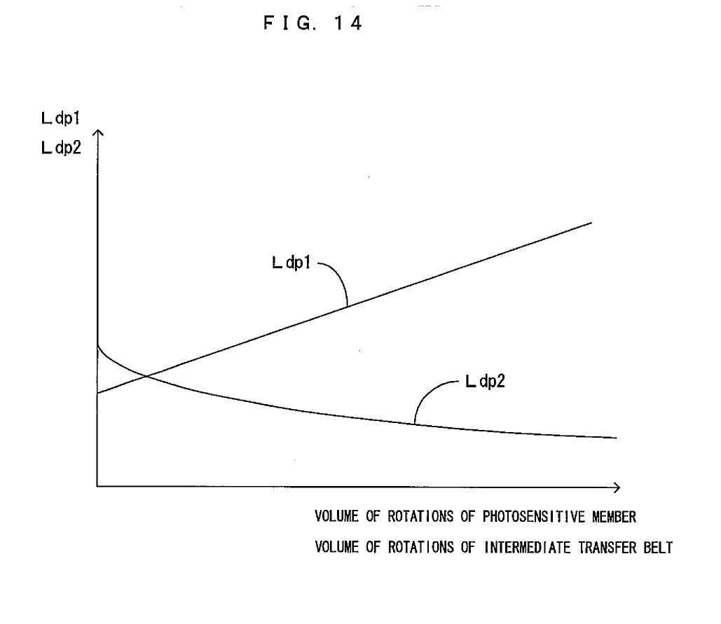

FIG. 14 is a first graph for determining the length of the patch image. Since the cleaner blade 251 corresponding to the photosensitive member 22 remains abutting on the photosensitive member 22, once toner has accumulated in this abutting section, the toner will not be easily lost. Further, since there always is steady presence of fogging-causing toner so to speak on the surface of the photosensitive member 22 during the ordinary image forming operation, a certain amount of toner is supplied to the abutting section between the photosensitive member 22 and the blade 251. The amount of toner thus supplied becomes greater, as the volume of rotations of the photosensitive member 22 during this increases. Hence, as for the amount of toner to feed to the abutting section between the photosensitive member 22 and the blade 251, the amount of toner may be increased when the volume of rotations of the photosensitive member 22 is small but decreased when this volume of rotations is large. The length Ldp2 of the image part Idp2 to be allocated to the photosensitive member 22 may therefore be shortened as this volume of rotations increases.

Meanwhile, since the intermediate transfer belt 71 does not carry fogging-causing toner as that on the photosensitive member 22 and since the cleaner 76 abuts on and moves away from the intermediate transfer belt, it is considered that more the intermediate transfer belt 71 operates, more the blade 763 take away toner. Therefore, the greater amount the intermediate transfer belt 71 rotates, the longer the length Ldp1 of the image part Idp1 to be allocated to the intermediate transfer belt 71 needs be.

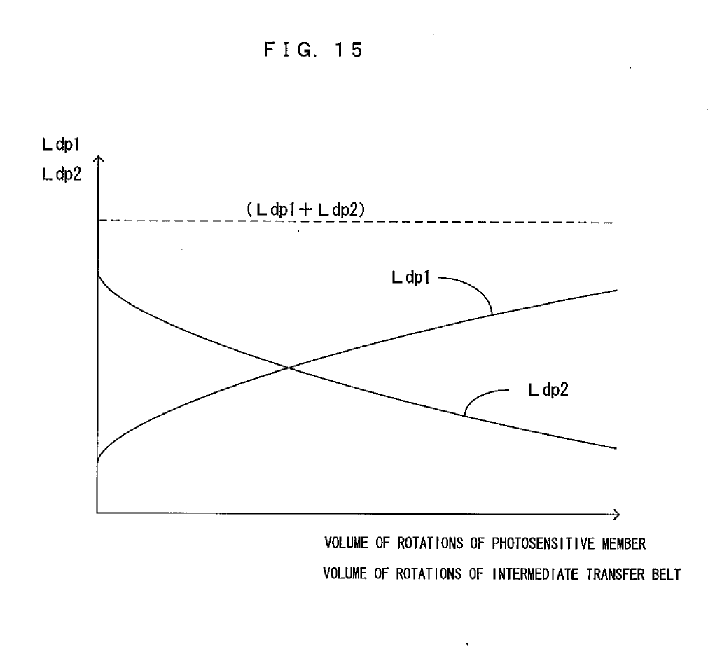

FIG. 15 is a second graph for determining the length of the patch image. As described above, the greater amount the photosensitive member 22 rotates, the shorter the image part Idp2 to be allocated to the photosensitive member 22 can be. In the meantime, the greater amount the intermediate transfer belt 71 rotates, the longer the length Ldp1 of the image part Idp1 to be allocated to the intermediate transfer belt 71 can be. It then follows from FIG. 15 that the total of the two lengths (Ldp1+Ldp2) may be set constant. This ensures that the length and the size of the toner-accumulating patch image Idp formed on the photosensitive member 22 are always constant and that the total amount of toner used to form the toner-accumulating patch image is always constant. This is advantageous in improving the accuracy of and simplifying the structure of a toner counter, if any to be separately disposed, which is for the purpose of calculating a toner consumption amount.

The toner accumulating processing will be described further with reference with FIG. 13 again. As the length of the toner-accumulating patch image is determined in this fashion, as in the new unit-triggered toner accumulating processing, the developer chosen in accordance with the predetermined criterion moves to the development position (Step S305), and using this developer, the toner-accumulating patch image Idp having the calculated length is formed (Step S306). This processing is also similar to the new unit-triggered toner accumulating processing in that as the primary transfer bias is switched, the toner-accumulating patch image Idp is allocated to the photosensitive member 22 and the intermediate transfer belt 71 and scraped off by the associated blades.

In the abutting section between the photosensitive member 22 and the blade 251 and the abutting section between the intermediate transfer belt 71 and the blade 763, proper amounts of toner in accordance with the respective use histories accumulate and realize the lubrication effect. Further, since the patch image formed through one operation is allocated as the primary transfer bias is switched, it is possible to efficiently accumulate toner in these abutting sections.

The integrated value of the number of revolution of the intermediate transfer belt 71 may be replaced with the number of times that the cleaner 76 abuts on and moves away. This is because while toner at the tip of the blade 763 disappears gradually also when the intermediate transfer belt 71 rotates with the cleaner 76 abutting on the same, depending on the structure of the apparatus, e.g., in the event that the apparatus does not comprise the toner stopper sheet 764, more toner may disappear in relation to the abut-on/move-away motion. If that is the case, the number of times that the blade 763 abuts on and moves away serves as a better indicator of the amount of toner at the tip of the blade 763 than the amount of rotations of the intermediate transfer belt 71 does, and therefore, the length of the part image Idp1 may be determined based on the number of times that the cleaner abuts on and moves away.

Further, information regarding the occurrence of a jam of the sheet S from the previous toner accumulating processing until the next toner accumulating processing may be factored in the length Ldp1 of the part image Idp1. Upon occurrence of a jam, the cleaner 76 removes an image already on the intermediate transfer belt 71 without any transfer of the image onto the sheet S. Since accumulation of toner thus scraped off is expected, it is possible to reduce the amount of toner to supply through the toner accumulating processing by the expected amount. Noting this, a constant amount per occurrence of a jam may for instance be deducted from the length Ldp1 of the part image Idp1 calculated in the manner described above. Besides, if a toner image is left on the photosensitive member 22 or the intermediate transfer belt 71 due to the lack of execution of the transfer step for any reason, the lengths of the part images Idp1 and Idp2 may be adjusted appropriately in accordance with the amount of toner of the surviving toner image.

(2) Toner accumulating processing for every certain counts representing the number of images formed

This processing is made possible, with replacement of timekeeping with the timer at Step S301 shown in FIG. 13 with counting of the number of images formed and replacement of the judgment at Step S302 with “whether the number of images formed has reached a predetermined count”.

In this instance, instead of merely counting the number of images formed, the value to count may be a value obtained by weighting the number of images by the print duty of each image, namely, the ratio of the area size of a toner adhering section to the total image size. Between one entirely solid image (having the duty of 100%) for instance and one characters/letters image with much white background (The duty is approximately 5% in an average characters/letters image for instance), the amounts of toner remaining on the photosensitive member 22 and the intermediate transfer belt 71 after the transfer step are naturally different. In other words, when a high-duty image is formed, more toner remains on the photosensitive member 22 and the intermediate transfer belt 71 than when an image having a lower duty is formed. Hence, the amount of toner to replenish to the tips of the blades through the toner accumulating processing may be changed depending upon the duty of each one of formed images. Describing this in more specific details, the lower the duty of an image which is formed is, less accumulating toner is replenished during the toner accumulating processing, and hence, more toner needs be supplied. In more general terms, the number of images may be counted while weighting this number by the duty of each image, and the toner accumulating processing may be executed when the count reaches a predetermined value.

Alternatively, while executing the toner accumulating processing itself merely based on the value which represents the number of images counted, information regarding the duty of each image may be taken into consideration in determining the length of each part image at each time.

(3) Toner accumulating processing executed every time the volume of rotations of the photosensitive member 22 reaches a certain value

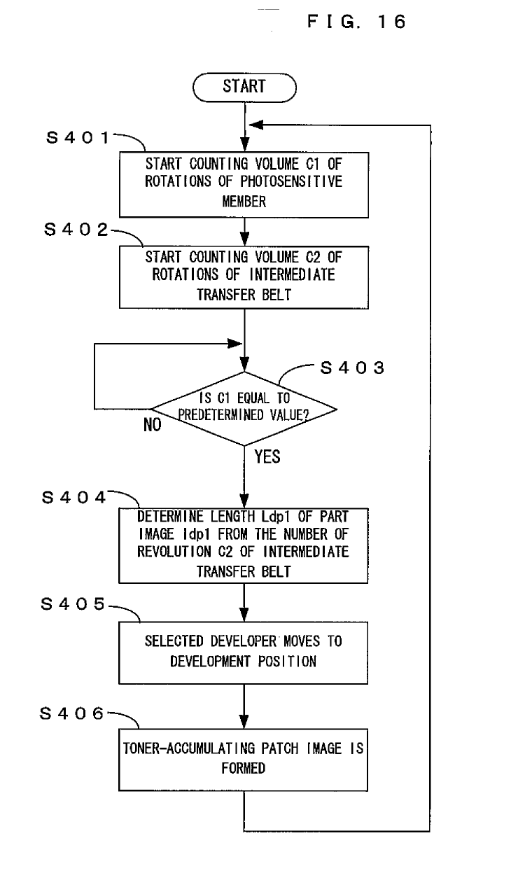

FIG. 16 is a flow chart of the toner accumulating processing executed based on the volume of rotations of the photosensitive member. During this processing, the first step is counting of the volume C1 of rotations of the photosensitive member 22 and the volume C2 of rotations of the intermediate transfer belt 71 (Step S401 and Step S402). When the volume C1 of rotations of the photosensitive member 22 reaches a predetermined value (Step S403), the length Ldp1 of the part image Idp1 is determined from the counted volume C2 of rotations of the intermediate transfer belt 71 (Step S404). Following this, as in the processing shown in FIG. 13, the developer chosen in accordance with the predetermined criterion moves to the development position (Step S405), and using this developer, the toner-accumulating patch image Idp having the calculated length is formed (Step S406). This processing remains unchanged in that as the primary transfer bias is switched, the toner-accumulating patch image Idp is allocated to the photosensitive member 22 and the intermediate transfer belt 71 and scraped off by the associated blades.

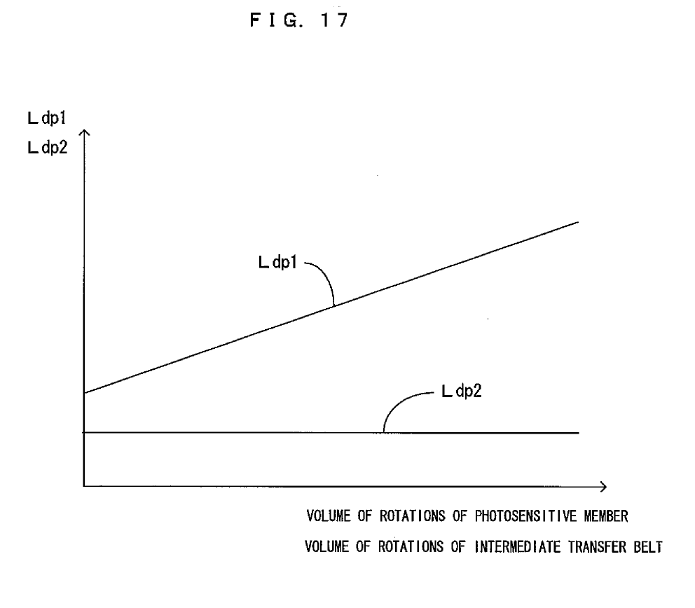

FIG. 17 is a third graph for determining the length of the patch image. Since the toner accumulating processing is executed every time the volume C1 of rotations of the photosensitive member 22 reaches the certain value, as shown in FIG. 17, the length Ldp2 of the image part Idp2 to be allocated to the photosensitive member 22 out of the toner-accumulating patch image Idp may have a constant value. Meanwhile, as for the length Ldp1 of the part image Idp1 to be allocated to the intermediate transfer belt 71, since the volume of rotations of the intermediate transfer belt 71 does not remain constant, the larger the counted volume C2 of rotations of the intermediate transfer belt 71 is, the longer this length is set.

(4) Toner accumulating processing executed every time the volume of rotations of the intermediate transfer belt 71 reaches a certain value

A partial modification of the processing shown in FIG. 16 realizes this processing. In short, when the counted volume C2 of rotations of the intermediate transfer belt 71 reaches a predetermined value at Step S403, the subsequent processing is executed, thereby setting the length Ldp1 of the part image Idp1 to a constant value and setting the length Ldp2 of the part image Idp2 to a value which is based on the counted volume C1 of rotations of the photosensitive member 22.

This embodiment thus requires executing the toner accumulating processing at predetermined timing, in addition to upon ascertainment that the photosensitive member cartridge 2 or the transfer unit 7 is new. During the toner accumulating processing triggered in this manner, the length of the toner-accumulating patch image is determined based on information regarding the use histories of the photosensitive member 22 and/or the intermediate transfer belt 71 since the previous toner accumulating processing until the present time. To be more specific, based on information representing the volumes of rotations of the photosensitive member and the intermediate transfer belt, the number of images formed, the duties of the images, the number of jams occurred, etc., the length Ldp1 of the part image Idp1 to be allocated to the intermediate transfer belt 71 and the length Ldp2 of the image part Idp2 to be allocated to the photosensitive member 22 out of the toner-accumulating patch image Idp are determined properly. In this embodiment, appropriate amounts of toner in accordance with the use histories of the photosensitive member 22 and the intermediate transfer belt 71 thus accumulate at the tips of the associated blades and realize the lubrication effect.

As described above, in this embodiment, through one patch image forming operation, the toner-accumulating patch image Idp is formed which is for supplying toner to each one of the abutting section between the photosensitive member 22 and the cleaner blade 251 and the abutting section between the intermediate transfer belt 71 and the cleaner blade 763. The toner is allocated as the primary transfer bias is switched. Hence, it is possible to efficiently execute the toner accumulating processing for accumulating toner in each one of the abutting section between the photosensitive member 22 and the cleaner blade 251 and the abutting section between the intermediate transfer belt 71 and the cleaner blade 763.

The toner-accumulating patch image is formed, avoiding a predetermined prohibited area on the surface of the photosensitive member 22. The prohibited area is a surface area on the surface of the photosensitive member 22 which is immediately after the blade 251 has scraped off the part image Idp2 not transferred onto the intermediate transfer belt 71 within the primary transfer region TR1. As the toner-accumulating patch image is formed avoiding this area, the amount of toner constituting the toner-accumulating patch image becomes stable. In consequence, it is possible to supply proper amounts of toner respectively to the abutting section between the photosensitive member 22 and the cleaner blade 251 and the abutting section between the intermediate transfer belt 71 and the cleaner blade 763.

Further, the toner accumulating processing is executed at the predetermined timing during the operation of the apparatus as well, and the size of the toner-accumulating patch image is determined in accordance with the use histories of the photosensitive member 22 and the intermediate transfer belt 71 during this processing. Hence, it is possible according to this embodiment to supply proper amounts of toner respectively to the abutting section between the photosensitive member 22 and the cleaner blade 251 and the abutting section between the intermediate transfer belt 71 and the cleaner blade 763.

As described above, in this embodiment, the developing unit 4 and the developers 4Y etc. mounted to the same function as the “developer” of the invention. The intermediate transfer belt 71 corresponds to the “intermediate transfer member” of the invention. Further, in this embodiment, the cleaner 25 and the cleaner 76 function as the “photosensitive member cleaner” and the “intermediate transfer member cleaner” of the invention, respectively. The engine controller 10 functions as the “controller” of the invention. In this embodiment, the toner-accumulating patch image Idp or Idp10 corresponds to the “toner-accumulating toner image” of the invention, of which the part image Idp1 or Idp11 corresponds to the “first area” of the invention and the part image Idp2 or Idp12 corresponds to the “second area” of the invention.

The invention is not limited to the embodiment described above but may be modified in various manners in addition to the embodiment above, to the extent not deviating from the object of the invention. For instance, although the embodiment above requires executing the print preparation operation right after power-on of the apparatus, the print preparation operation is not indispensable to the invention but may instead be omitted or a processing operation may be appropriately added to the print preparation operation.

Further, although whether the transfer unit is new or old is determined only immediately after power-on of the apparatus in the embodiment described above, this is not limiting: whether the transfer unit is new or old may be always determined. However, if exchange of the unit is done only with the power turned off, judging if the unit is new only upon power-on as in the embodiment described above is sufficient.

Further, the photosensitive member 22 and the cleaner 22 are structured so as to be attachable to and detachable from the main apparatus section as an integrated cartridge while the intermediate transfer belt 71 and the cleaner 76 form the transfer unit 7 which is attachable to and detachable from the main apparatus section as an integrated part in the embodiment described above. Instead, the photosensitive member and the cleaner may form separate units or the intermediate transfer belt and the cleaner may form separate units, in which case the toner accumulating processing must be performed when any one of these members is new.

Further, the invention is not applicable only to an apparatus which comprises a rotary developing unit as described above in relation to the embodiment, but may be applied generally to any image forming apparatus which comprises a photosensitive member, an intermediate transfer member and cleaners which respectively abut on these and remove toner, including an image forming apparatus of the so-called tandem type and an image forming apparatus which forms an image utilizing other principle than the electrophotographic principle.

The foregoing has described execution of the processing for feeding toner to and accumulating the toner in each one of the abutting section between the photosensitive member and the associated cleaner and the abutting section between the intermediate transfer belt and the associated cleaner as one continuous processing. However, the toner accumulating processing for the abutting section between the photosensitive member and the associated cleaner and that for the abutting section between the intermediate transfer belt and the associated cleaner may be performed separately from each other. Now, a description will be given on a preferred mode of processing which aims at accumulating toner in either one of the abutting section between the photosensitive member and the associated cleaner and the abutting section between the intermediate transfer belt and the associated cleaner.

Among image forming apparatuses which form images using toner is one which is structured so that a toner image formed by an image forming unit is primarily transferred onto an intermediate transfer member temporarily and the image is secondarily transferred further onto a recording medium such as a paper. Such an intermediate transfer member may be one having a multi-layer structure in which different materials are stacked one atop the other for the purpose of satisfying both the demanded toughness and the demanded excellent transferability. For instance, the image forming apparatus according to JP-A-11-282288 comprises an intermediate transfer member which is composed of an insulating base member made of synthetic resin, a conductive layer formed on the insulating base member and a resistive layer formed on the conductive layer, and as a predetermined primary transfer voltage is applied upon the conductive layer, an excellent transfer characteristic is obtained.

This type of image forming apparatus often comprises a cleaner which abuts on an intermediate transfer member and removes toner, in which case friction with the intermediate transfer member due to friction with the cleaner is a problem. This emerges as a particularly serious problem where an intermediate transfer member having a multi-layer structure as that according to the conventional technique is used. This is because a thin surface layer is likely to be damaged or change its characteristic owing to friction and because friction-induced exposure of the conductive layer beneath the surface layer could result in short circuit.

To deal with these problems, such toner accumulating processing may be executed during which an image forming element forms a toner-accumulating patch image having a predetermined pattern on an intermediate transfer member, this toner image is sent into the abutting section between the intermediate transfer member and a cleaner and toner is accumulated near this abutting section, for instance. Since this makes the toner building up in the abutting section between the cleaner and the intermediate transfer member serve as a lubricant between the cleaner and the intermediate transfer member, it is possible to effectively suppress wear of the intermediate transfer member. Further, since the cleaner removes the toner image formed by the image forming unit, thus allowing accumulation of toner in the abutting section, no particular structure for the toner accumulating processing is necessary.

Now, a description will be given on a technique applicable to an image forming apparatus comprising an intermediate transfer member having a multi-layer structure and on an image forming method with which it is possible to suppress wear of the intermediate transfer member, and particularly, wear of the surface layer of the intermediate transfer member. The structure of the apparatus serving as the premise of the following description is basically the same as that of the image forming apparatus described above.

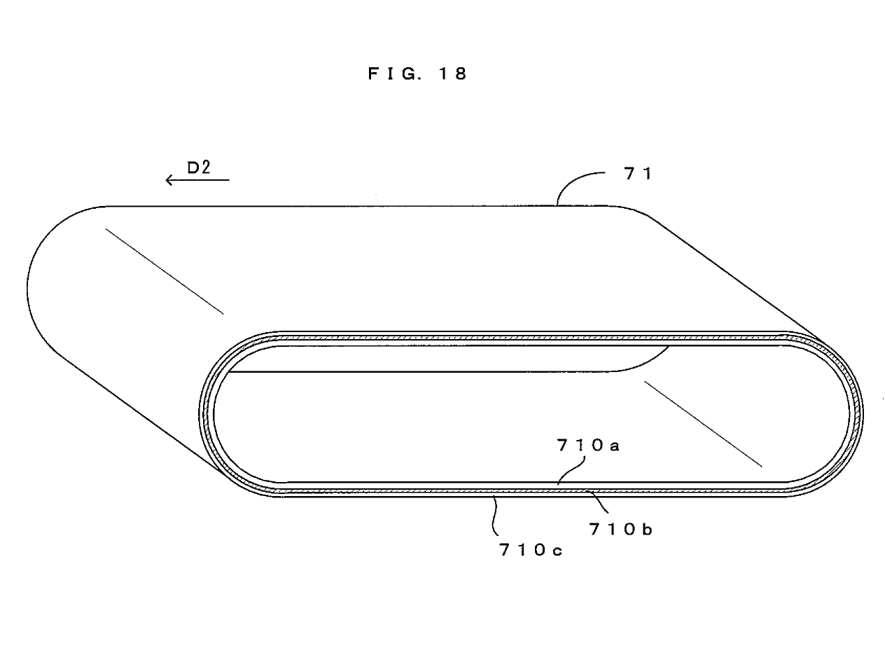

FIG. 18 is a drawing which shows the structure of an intermediate transfer belt. The intermediate transfer belt 71 is an endless belt which is obtained by stacking a base member 710a of insulating synthetic resin, a conductive layer 710b made of a conductive material and a resistive surface layer 710c made of a resistive material whose specific resistance is greater than that of the conductive layer in this order. While PET (polyethylene terephthalate) resin may typically be used for the base member 710a, it is acceptable to use other material which may be polyester resin, acrylic resin, polycarbonate resin, polyimide, etc. Besides a metallic vapor-deposited film of tin, aluminum or the like, a conductive paint prepared by mixing conductive particles, such as metallic particles or carbon particles, in a resin material may be used for the conductive layer 710b. The surface layer 710c may be made of urethane paint containing a conductive material (tin oxide, indium oxide, zinc oxide, titanium oxide, carbon, etc.) for adjusting the specific resistance and fluorine-contained resin microparticles.

The intermediate transfer belt 71 having such a structure has, owing to its base member 710a, the necessary mechanical strength and flexibility. Further, as a bias applying element not shown applies a predetermined primary transfer bias upon the conductive layer 710b, the primary transfer characteristic of a toner image from the photosensitive member 22 within the primary transfer region TR1 improves. In addition, the resistive surface layer 710c disposed on the surface improves the transfer characteristic onto the sheet S within the secondary transfer region TR2 which will be described later. The structure of the intermediate transfer belt 71 is not limited to this, but may be the structure described in JP-A-2002-365930 for instance.

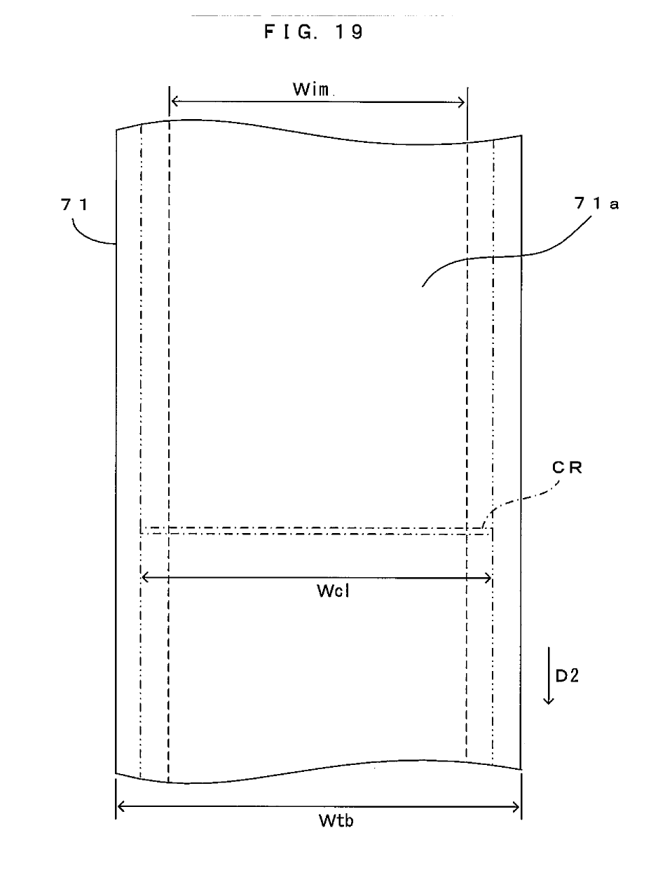

FIG. 19 is a drawing which shows the surface of the intermediate transfer belt. In the following, the area on the intermediate transfer belt 71 where the blade 763 of the cleaner 76 contacts the intermediate transfer belt 71 at a certain point of time will be called a “contact region CR”. As the intermediate transfer belt 71 moves, this contact region CR moves on the intermediate transfer belt 71 along the opposite direction to a belt travel direction D2. Of the surface area of the intermediate transfer belt 71, an area which moves passed this contact region with the cleaner 76 as the intermediate transfer belt 71 rotates one revolution with the cleaner 76 staying in contact with the intermediate transfer belt 71, namely, the area held between the two chain double-dashed lines in FIG. 19 is an area in which the cleaner 76 can remove residual toner. In the following description, this surface area will be referred to as a “cleaning region”. The widths of the contact region and the cleaning region in the direction (width direction) orthogonal to the travel direction D2 of the intermediate transfer belt 71 are the same as the width Wc1 of the cleaner blade 763, and this width Wc1 is wider than the width Wim of the image forming region 71a which is held between two dotted lines in FIG. 19 as described earlier.

As the ordinary image forming operation is executed, the image forming region 71a will inevitably find within itself residual toner failing to get transferred to the sheet S in the secondary transfer region TR2. This is because the secondary transfer rate is less than 100%. The cleaner 76 scrapes off such residual toner, a part of which builds up in the toner reservoir space SP which is at the tip of the blade 763 and contributes to reduction of friction between the blade 763 and the intermediate transfer belt 71.

On the other hand, in principle, there will not be such residual toner outside the image forming region 71a. This is a very different phenomenon than that occurring on the surface of the photosensitive member 22, but is unique to an intermediate transfer member such as the intermediate transfer belt 71. There is commonality between the photosensitive member 22 and the intermediate transfer belt 71 in that a toner image is formed as a result of the ordinary image forming operation only inside the image forming region. However, toner usually called “fogging-causing toner” charged to the opposite polarity is distributed all over the photosensitive member after development, and such toner will remain on the photosensitive member 22 without getting transferred onto the intermediate transfer belt 71 due to the function of the primary transfer bias. The surface of the photosensitive member 22 moving passed the primary transfer region TR1 therefore seats toner, although in a small amount, adhering to even outside the image forming region.

In contrast, on the intermediate transfer belt 71 moving passed the primary transfer region TR1 and the secondary transfer region TR2, there is almost no toner adhering to outside the image forming region 71a. Outside the image forming region therefore, friction occurs between the blade 763 and the surface of the intermediate transfer belt 71 without almost any supply of toner realizing the lubrication effect. This is likely to cause lapped ends of the blade 763, wear of the surface layer 710c of the intermediate transfer belt 71 and the like in this portion. Wear of the surface layer 710c of the intermediate transfer belt 71 alters the transfer characteristic of a toner image and adversely affects the quality of an image. Meanwhile, exposure of the conductive layer 711b which is an inner layer results in short circuit with the photosensitive member 22 or discharging and hence could damage the apparatus.

Further, since the cleaner 76 abuts on and moves away from the intermediate transfer belt 71, it is difficult to maintain a stable amount of accumulated toner at the tip of the blade 763. This is another aspect that cleaning techniques for the photosensitive member 22 with which it is possible to keep the cleaner always abutting on the photosensitive member 22 do not take into consideration.

It is therefore preferable to execute the following toner accumulating processing when needed. The toner accumulating processing aims at always securing a stable amount of accumulated toner in the abutting section between the blade 763 and the intermediate transfer belt 71 to thereby prevent wear of the intermediate transfer belt 71, the lapped ends of the blade 763, etc. The following will consider examples of executing the toner accumulating processing at three different timing: (1) when the photosensitive member cartridge 2 or the transfer unit 7 is new; (2) when the number of images formed has reached a predetermined count; and (3) when a condition controlling operation (which will be described later) is to be performed which optimizes operating conditions of the apparatus during the image forming operation for the purpose of maintaining an image quality. The mode of the toner accumulating processing is different depending upon a condition to initiate these processing.

(1) Toner Accumulating Processing Executed when the Photosensitive Member Cartridge 2 or the Transfer Unit 7 is New

When the transfer unit 7 is new, there is of course no accumulated toner at the tip of the blade 763. Meanwhile, exchange of the photosensitive member cartridge 2 temporarily releases the tension upon the intermediate transfer belt 71, and vibrations or the like at that time could splash toner which is present at the tip of the blade. Noting this, when these units are new, the first toner accumulating processing described below is performed. As for judgment of whether each unit is new, a similar method to that according to the earlier embodiment may be used.

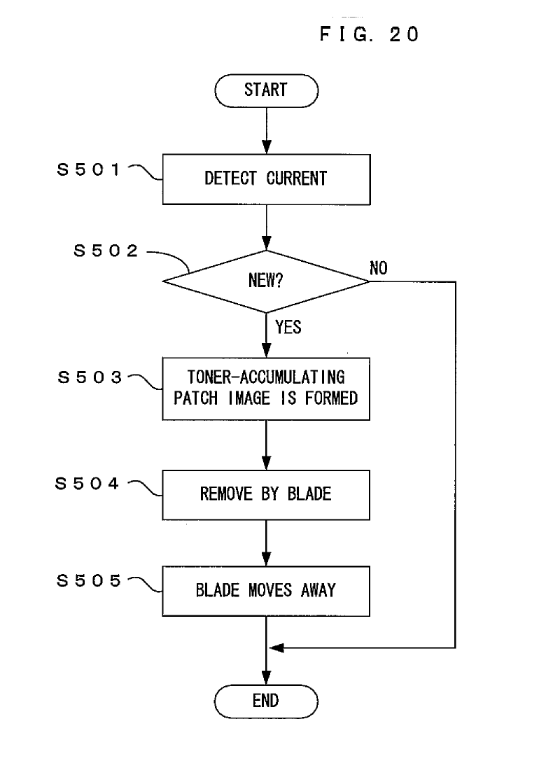

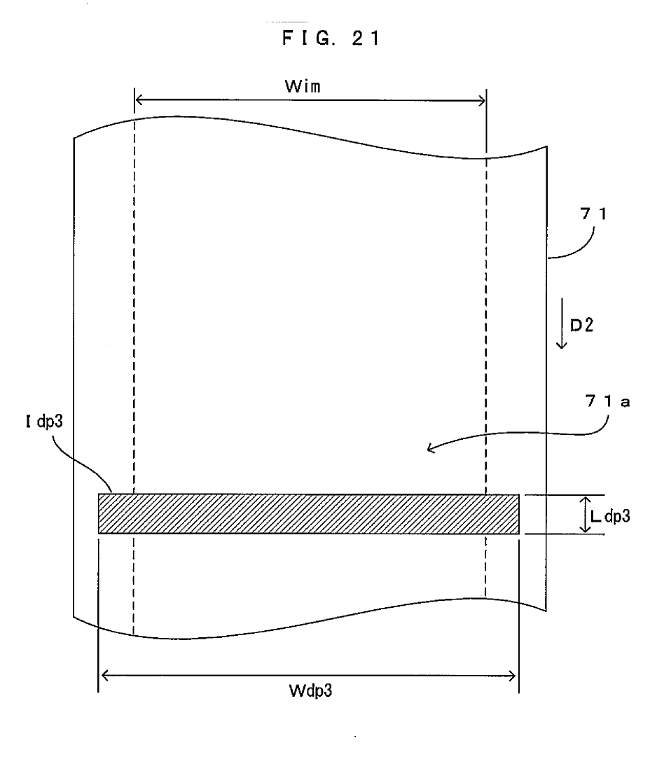

FIG. 20 is a flow chart of the operation immediately after power-on. After power-on of the apparatus, the CPU 101 detects whether the photosensitive member cartridge 2 and the transfer unit 7 are new (Step S501). When either one is found to be new, the toner accumulating processing starting at Step S503 is executed. On the contrary, when neither is new, the processing is terminated (Step S502). At Step S503, the toner-accumulating patch image shown in FIG. 21 is formed.

FIG. 21 is a drawing of a third example of the toner-accumulating patch image. The toner-accumulating patch image Idp3, as shown in FIG. 21, is a strip-like image extending along the width direction which is orthogonal to the travel direction D2 in which the intermediate transfer belt 71 moves. Although the image pattern of the toner-accumulating patch image may be any desired pattern, the toner-accumulating patch image may be a uniformly solid image or a halftone image for instance as such an image is easy to form. The length Ldp3 of the toner-accumulating patch image Idp3 along the travel direction D2 of the intermediate transfer belt 71 is set to be a necessary length to supply to the abutting section with the blade 763 a sufficient amount of toner for toner accumulation in the toner reservoir space SP.

The width Wdp3 of the toner-accumulating patch image Idp3 is set as follows. For prevention of wear of the intermediate transfer belt 71, the lapped ends of the blade 763, etc., toner needs accumulate along the entire width of the blade 763. Hence, the width Wdp3 of the toner-accumulating patch image Idp3 is preferably wider than the width Wim of the image forming region 71a which is created on the intermediate transfer belt 71 in accordance with the sheet size, and if possible, about the same as the blade width Wc1. However, since the cleaner 76 can not remove toner adhering to the intermediate transfer belt 71 beyond the blade width, the width Wdp3 of the toner-accumulating patch image Idp3 should not exceed the blade width. A part of toner thus scraped off is expected to spread beyond the width of the toner-accumulating patch image within the toner reservoir space SP. The width Wdp3 of the toner-accumulating patch image Idp3 is therefore preferably wider than the width Wim of the image forming region but somewhat narrower than the width Wc1 of the blade.

The dimensions of the photosensitive member 22, the developing roller 44 and the like also influence the width of the surface area within the surface of the intermediate transfer belt 71 to which toner can physically adhere from the developing roller 44, that is, the width of the “maximum development area”. In the event that the widths of these members are narrower than the blade width Wc1 and the dimensions of these members restrict the width of the maximum development area, it is desirable to form the toner-accumulating patch image Idp3 all along this maximum development width.

As such a toner-accumulating patch image Idp3 is formed and scraped off by the blade 763 (Step S504 in FIG. 20), toner accumulates in the toner reservoir space SP which is at the tip of the blade 763. Toner accumulating in this manner serves to effectively prevent wear of the intermediate transfer belt 71, damage of the blade 763, etc. As accumulation of toner finishes, the blade 763 moves away from the intermediate transfer belt 71 and the apparatus switches to its stand-by state (Step S505).

(2) Toner Accumulating Processing Executed when the Number of Images Formed has Reached a Predetermined Count

The content of the toner accumulating processing in this instance is the same as that of the toner accumulating processing performed after detection of a new unit described above (Step S503 to Step S505 in FIG. 20). However, a toner-accumulating patch image to form is different from the toner-accumulating patch image Idp3 described above.

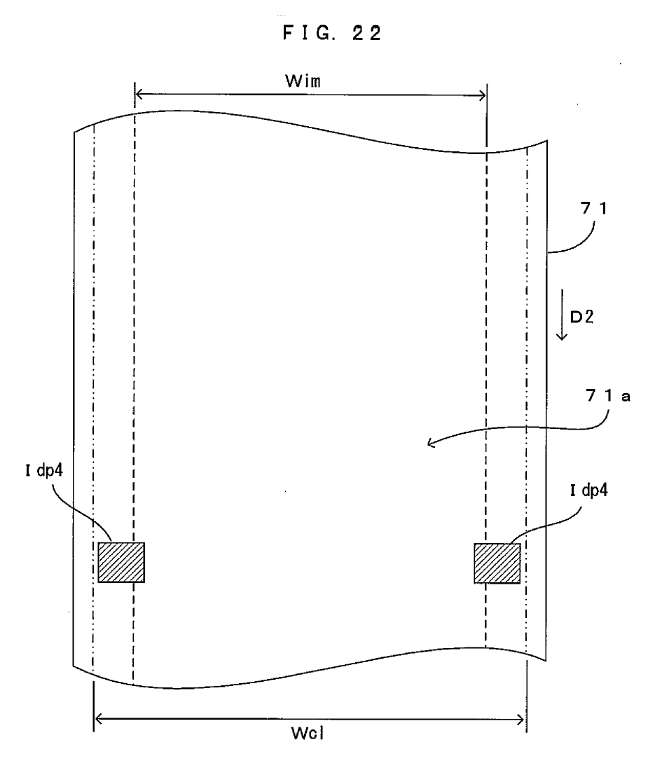

FIG. 22 is a drawing of a fourth example of the toner-accumulating patch image. The illustrated toner-accumulating patch image Idp4, as shown in FIG. 22, is formed only near the ends of the intermediate transfer belt 71 along the width direction of the intermediate transfer belt 71. The shape of the toner-accumulating patch image Idp4 corresponds to that of the toner-accumulating patch image Idp3 as it is exclusive of the section encompassed in the image forming region 71a. This is because residual toner appearing in the image forming region due to execution of the ordinary image forming operation is expected to accumulate in a portion of the tip of the blade 763 which corresponds to the image forming region. As the toner-accumulating patch image Idp4 excluding the image forming region is formed, it is possible to ensure the lubrication effect owing to toner all over the cleaning region and suppress wasteful consumption of toner while preventing wear of the intermediate transfer belt 71, the lapped ends of the blade 763, etc.

The inner ends of the toner-accumulating patch image Idp4 shown in FIG. 22 are slightly inside the outer borders (denoted at the dotted lines) of the image forming region 71a, and the outer ends of the toner-accumulating patch image Idp4 are slightly inside the outer borders (denoted at the chain double-dashed lines) of the cleaning region. The reason of locating the inner ends of the toner-accumulating patch image Idp4 slightly inside the outer borders of the image forming region 71a is because the partial overlap of the toner-accumulating patch images with the image forming region will make toner accumulation more secure near the ends of the image forming region. However, this is not limiting. Instead, the inner ends of the toner-accumulating patch image Idp4 may be located approximately at or slightly outside the outer borders of the image forming region. Meanwhile, the outer ends of the toner-accumulating patch image Idp4 are positioned slightly inside the outer borders of the cleaning region, to thereby prevent scraped-off toner from flowing over even beyond the cleaning region and remaining on the belt without getting removed.

Further, instead of merely counting the number of images formed, the number of color images formed and the number of monochrome images formed may be counted separately, and the toner accumulating processing may be executed when a value calculated by appropriately weighting these counts and adding the weighted values has reached a predetermined value. This is because between color images and monochrome images, although the same numbers of them are formed, cause the cleaner 76 to abut on and move away for different number of times and the amount of toner building up at the tip of the blade 763 is accordingly different. In short, to form monochrome images, the cleaner 76 may stay abutting on the intermediate transfer belt 71. In contrast, to form color images, it is necessary to repeat an operation of keeping the cleaner 76 away from the intermediate transfer belt 71 while superimposition of toner images of the respective colors on the intermediate transfer belt 71 but contacting the cleaner with the intermediate transfer belt after secondary transfer of a color image onto the sheet S.

(3) Toner Accumulating Processing Executed Together with the Condition Controlling Operation

This apparatus forms a patch image right after powered on, and based on the detected density of the patch image, performs the condition controlling operation which is for adjusting an image forming operation condition of the apparatus. Further, the toner accumulating processing is executed concurrently with the condition controlling operation. There are numerous known techniques regarding the condition controlling operation. Since these known techniques may be applied appropriately to this embodiment, the principle, the details and the like of the operation will not be described below.

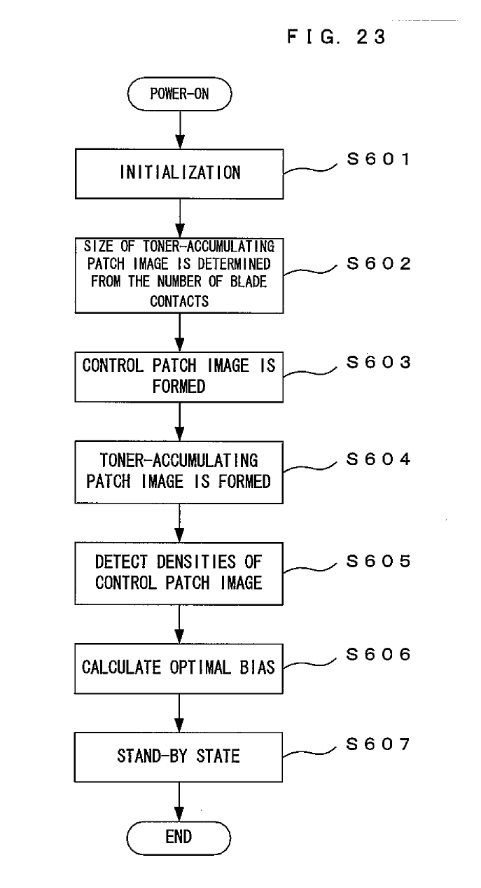

FIG. 23 is a flow chart of the condition controlling operation. Upon power-on of the apparatus, the engine controller 10 initializes the respective portions of the apparatus (Step S601). The initializing operation at this stage includes an operation for moving the developing unit 4 to a predetermined home position, an operation for detecting the location of the intermediate transfer belt 71, an operation for increasing the temperature of the fixing unit 9 to a predetermined fixing temperature, etc. At this stage, the number of contacts of the blade 763 with the intermediate transfer belt 71 since the previous toner accumulating processing until the present time stored in the RAM 107 is read, and based on thus read value, the length Ldp5 of a toner-accumulating patch image Idp5 to form later is determined (Step S602). The details will be given later.

Next, from among operation parameters regarding the respective portions of the apparatus, one or multiple parameters influencing the density of an image are determined as density controlling factor, and while varying the values of the density controlling factors over multiple stages, predetermined control patch images are formed (Step S603). In the following, the developing bias applied upon the developing roller 44 will be described as such a density controlling factor.

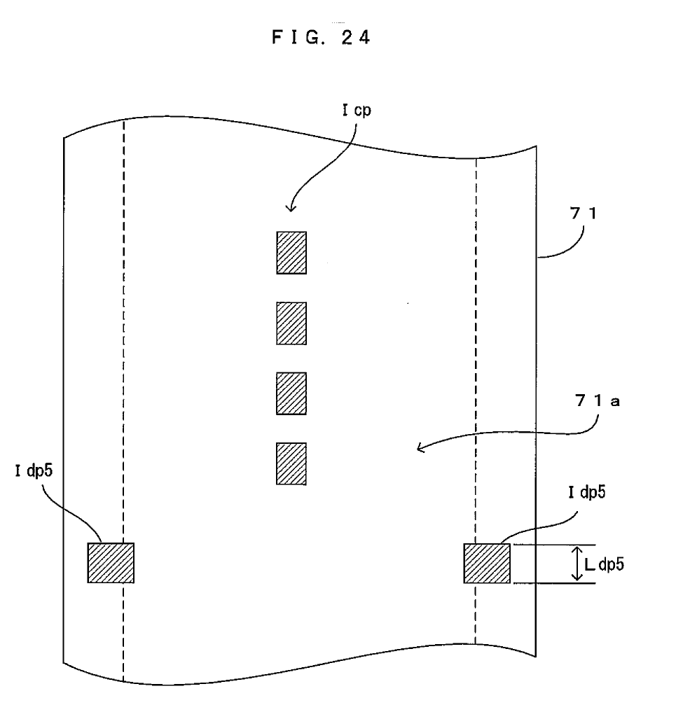

FIG. 24 is a drawing of a patch image during the condition controlling operation. The patch image Icp shown in FIG. 24 is formed by four image segments having the same pattern formed at different set values of the developing bias varied over four levels. The respective image segments are formed at different locations from each other along the travel direction D2 of the intermediate transfer belt 71. The density sensor 60 later detects the density of the patch image Icp and this density is used for calculation of an optimal value of the developing bias.

Following the patch image Icp, the toner-accumulating patch image Idp5 is formed near the ends of the intermediate transfer belt 71 along the width direction of the intermediate transfer belt 71 (Step S604). The location and the width of the toner-accumulating patch image Idp3 along the width direction of the intermediate transfer belt 71 may be similar to those of the toner-accumulating patch image Idp4 (FIG. 22) described earlier. However, the length Ldp5 of the toner-accumulating patch image Idp5 is the length determined at Step S602 earlier.

To be more specific, more times the blade contacts since the previous toner accumulating processing until the present time, the longer the length Ldp5 of the toner-accumulating patch image Idp5 must be. This ensures that more times the blade contacts, the greater the amount of toner fed into the abutting section between the blade 763 and the intermediate transfer belt 71 becomes. It is therefore possible to recover the amount of accumulated toner at the tip of the blade lost by the abut-on/move-away motion. As the length Ldp5 of the toner-accumulating patch image Idp5 is changed depending upon whether the number of contacts is a large number of a small number in this manner, it is possible to stably maintain the amount of accumulated toner at the blade tip and prevent the lapped ends of the blade.

Next, the outputs from the density sensor 60 are sampled when the patch image Icp on the intermediate transfer belt 71 moves immediately below the density sensor 60. The densities of the image segments forming the patch image Icp are thus detected (Step S605). The blade 763 scrapes off the patch image Icp whose densities have been detected and the toner-accumulating patch image Idp5, and the toner constituting these images accumulates near the tip of the blade 763. Due to the toner stopper sheet 764, the toner accumulating in this way remains near the tip of the blade 763 instead of falling off even when the cleaner moves away.

Following this, from the detected densities of the patch image Icp, an optimal value of the developing bias which will make an image density a predetermined target density is calculated (Step S606). The RAM 107 stores the optimal developing bias values for the respective toner colors calculated in this manner, and thus calculated optimal developing bias values are applied upon the developing roller 44 to form images in the respective toner colors. It is therefore possible to form an image at the target density.

When image formation is to be continued, the image forming operation is performed with thus calculated optimal developing bias, but unless otherwise, the apparatus switches to its stand-by state and waits for the image formation command (Step S607). At this stage, the cleaner 76 as well moves to its stand-by position.

In this example, concurrently with the condition controlling operation which is for determining the operating conditions for the apparatus, the toner accumulating processing is executed during which the toner-accumulating patch image is formed and scraped off by the blade 763. In this fashion, it is possible to shorten the time required for the operations other than the image forming operation and reduce the waiting time for a user. Further, the toner-accumulating patch image Idp5 in this example aims at adhesion of toner only to the vicinity of the intermediate transfer belt 71. This is because it is expected in a central section of the intermediate transfer belt 71 that the toner constituting the patch image Icp will be scraped off and accumulate at the tip of the blade 763 and it is therefore unnecessary to supply further toner using another toner-accumulating patch image. In other words, the patch image Icp formed for control of the operating conditions for the apparatus is used as a part of the toner-accumulating patch image in this example.

Meanwhile, one can not expect toner scraped off near the central section to move beyond the image forming region. Therefore, toner is supplied using the toner-accumulating patch image Idp5 for such a portion, thereby effectively preventing the lapped ends of the blade 763 and the like all over the blade 763. As supply of toner by means of the toner-accumulating patch image is thus omitted for a region which can expect supply of toner due to other factor, wasteful consumption of toner is suppressed.

As described above, in this example, when the photosensitive member cartridge 2 or the transfer unit 7 is new, when the number of images formed has reached the predetermined count or at the time of execution of the condition controlling operation which is for optimization of the operating conditions for the apparatus, the toner accumulating processing is executed during which the toner-accumulating patch image is formed, the blade 763 scrapes if off and toner accumulates at the blade tip. To be noted in particular is that toner is made to accumulate even outside the image forming region. Hence, the lubrication effect of toner reduces friction between the intermediate transfer belt 71 and the blade 763 and suppresses wear of the intermediate transfer belt 71, damage of the blade 763, etc.

Of the above, during the toner accumulating processing executed when the photosensitive member cartridge or the transfer unit is new, since the toner-accumulating patch image Idp3 stretching almost all across the cleaning region is formed, it is possible to suppress wear of the intermediate transfer belt 71 entirely in the cleaning region. Meanwhile, during the toner accumulating processing executed when the number of images formed has reached the predetermined count, since the toner-accumulating patch image Idp4 is formed only near the ends of the cleaning region, it is possible to suppress wasteful consumption of toner while effectively suppressing wear of the intermediate transfer belt 71. Further, as the patch image Icp formed through the condition controlling operation is used as a part of the toner-accumulating patch image, it is possible to further suppress consumption of toner.

While the toner-accumulating patch image according to the embodiment above is either a strip-like image stretching beyond the image forming region 71a on the intermediate transfer belt 71 (FIG. 21) or an image stretching from near the ends of the image forming region 71a to outside the image forming region 71a (FIG. 22), the shape of the toner-accumulating patch image is not limited to these but may be any desired shape. An example may be an image whose shape will make toner adhere only to outside the image forming region on the intermediate transfer belt 71.

Further, while the cleaner 76 according to the embodiment above includes the toner stopper sheet 763 which keeps a predetermined amount of toner even at the stand-by position, the toner stopper sheet is not an indispensable structure. The invention is applicable also to an apparatus which uses a cleaner which does not include a toner stopper sheet, and rather effective when used in such an apparatus. This is because a cleaner which does not include a toner stopper sheet tends to lose accumulated toner at the blade tip in response to the abut-on/move-away motion and application of the invention to such an apparatus can effectively suppress the lapped ends of the blade.

Further, while the cleaner according to the embodiment above revolves about the predetermined rotation axis to thereby abut on and move away from the intermediate transfer belt, the abut-on/move-away mechanism is not limited to this: the technique above is applicable also to an apparatus in which a cleaner, by its slide motion, abuts on and moves away from an intermediate transfer member.

An example will now be discussed that an image carrier such as a photosensitive member or an intermediate transfer member has splice on its surface, that is, the image carrier has a structure obtained by joining together the both ends of a strip-like material whose surface is capable of carrying a toner image.

In an image forming apparatus having such a structure, when a cleaner abuts on an image carrier having a splice as described above, the cleaner could get caught by the splice and partially deformed or damaged, which is a likely problem. To solve this problem, JP-A-2001-215817 for instance describes a transfer belt obtained by joining together the both ends of a sheet-like member with sufficient joining strength and a method of manufacturing such a transfer belt.

In reality however, manufacturing of an image carrier perfectly free from discontinuity such as a step over a splice is not always easy from a manufacturing technique or cost point of view. In addition, since external force attributable to friction with the image carrier acts upon the cleaner which is pressed against the image carrier, elimination of a step will not automatically eliminate deformation, damage or the like of the cleaner. In light of this, slight discontinuity over a splice of an image carrier is accepted, which has given rise to a demand for a technique with which it is possible to prevent deformation, damage or the like of a cleaner more securely. Such a technique has not been however established so far. A description will be given on a technique applicable to an image forming apparatus which uses an image carrier having a splice with which it is possible to prevent deformation, damage or the like of a cleaner more securely.

In a first mode for secure prevention of deformation, damage or the like of a cleaner, defining a direction orthogonal to the travel direction in which the image carrier moves is a width direction for example, each one of joining lines on the surface of the image carrier formed by a splice of the image carrier at the both ends along the width direction of an image forming region within the surface of the image carrier in which an image forming unit forms a toner image is inclined such that the joining line is tilted toward the rear side along the travel direction with a distance toward outside the image carrier along the width direction.

In a second mode, the length along the width direction of the contact region where the cleaner and the image carrier are in mutual contact is longer than the length along the width direction of the image forming region within the surface of the image carrier in which the image forming unit forms a toner image, and further in the vicinity of the both ends of the image forming region on the image carrier taken along the width direction, the splice of the image carrier draws backward along the travel direction with a distance toward the ends of the image forming region along the width direction.

Further, in a third mode, as the image carrier moves, the splice of the image carrier located inside the image forming region within the surface of the image carrier in which the image forming unit forms a toner image arrives at the contact region with the cleaner before the splice of the image carrier located outside the image forming region along the width direction does.

Where these structures are used, the cleaner scrapes off toner which is left adhering within the image forming region of the surface of the image carrier and the toner thus scraped off functions as a lubricant between the image carrier and the cleaner, which prevents deformation, damage or the like of the cleaner. Further, since toner is supplied even to outside the image forming region along the step at the splice, the toner can function as a lubricant even near the ends of the cleaner to which no toner will be fed through ordinary image formation, which in turn makes it unlikely to cause the lapped ends at the cleaner. Image forming apparatuses having these structures can use even an image carrier having a somewhat noticeable splice without any problem, and prevent deformation, damage or the like of the cleaner without fail. In addition, reduced friction with the cleaner suppresses wear of the image carrier.

A more specific structure will now be described. In the description below as well, the structure of the apparatus serving as the premise of the description is basically the same as that of the image forming apparatus described above. As described later however, the structure of the intermediate transfer belt is partially different.

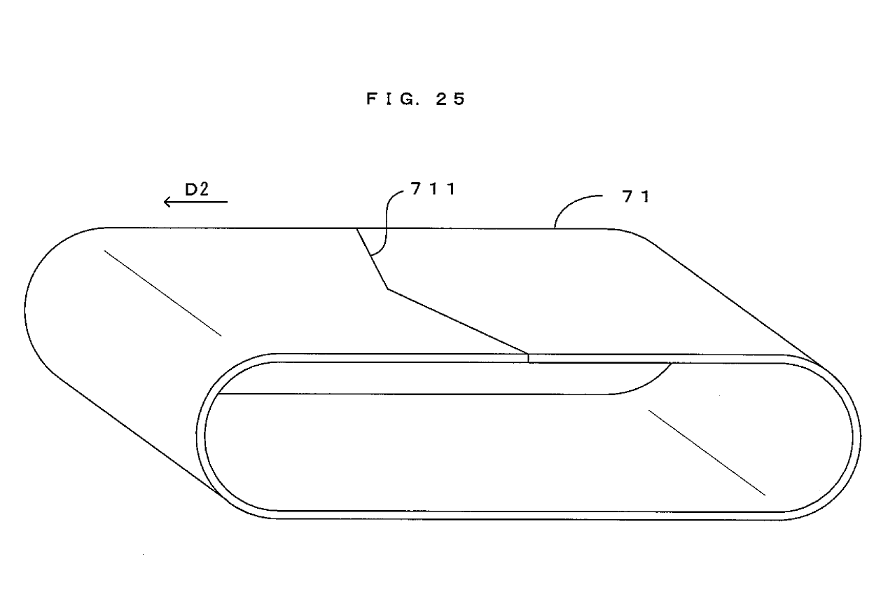

FIG. 25 is a drawing which shows other example of the structure of the intermediate transfer belt 71. The intermediate transfer belt 71 is an endless belt which is obtained by joining together the both ends of a strip-like member whose surface is capable of carrying a toner image. As shown in FIG. 25, a splice 711 is not linear but is shaped like the letter “V” with its central section protruding toward the travel direction D2. The reason of this shape will be described later in detail.

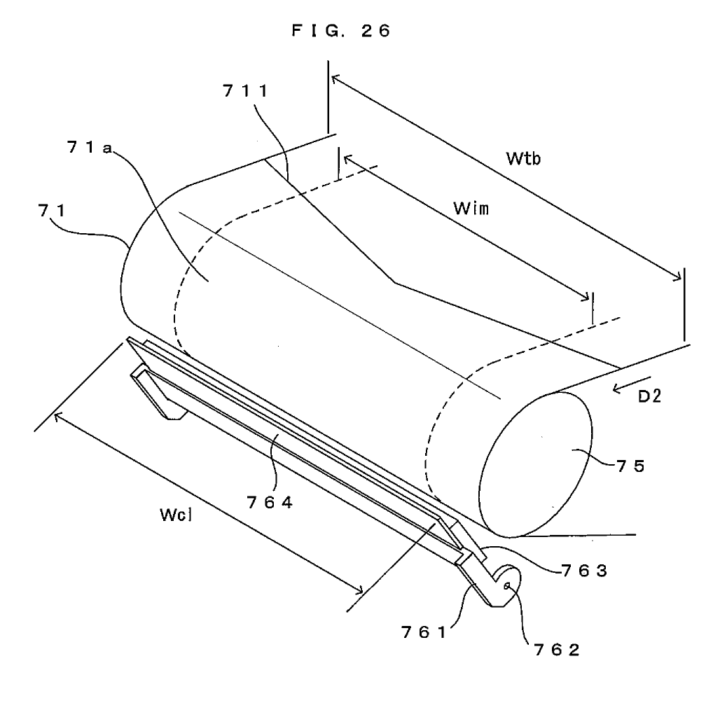

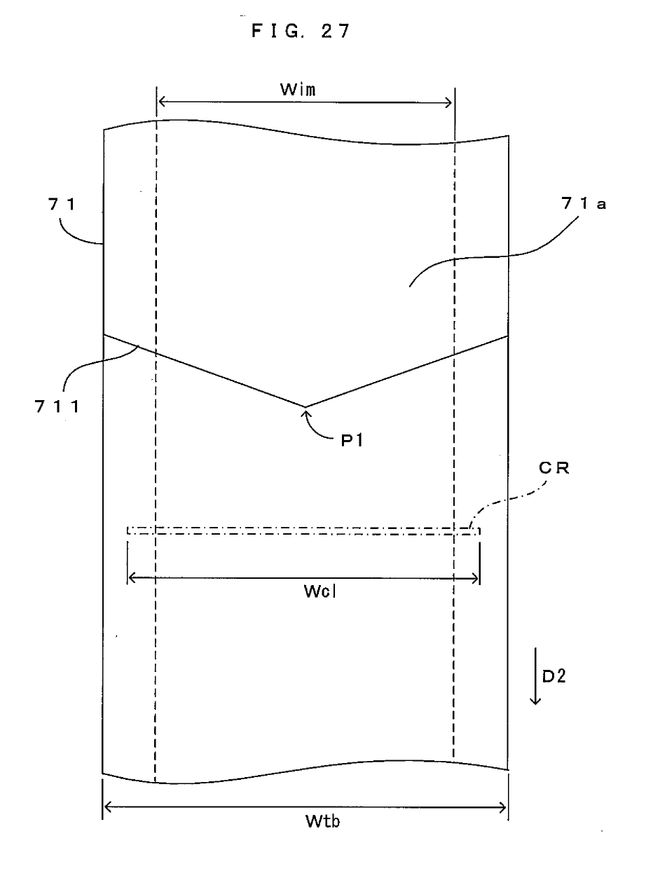

FIG. 26 is a perspective view for describing the dimensions of the cleaner and the intermediate transfer belt. FIG. 27 is a drawing of the splice of the intermediate transfer belt. As shown in FIGS. 25 through 27, the splice 711 of the intermediate transfer belt 71 is not linear but V-shaped with its central section P1 protruding toward the belt travel direction D2 in this embodiment. The reason of this will now be described. In the following, an area on the intermediate transfer belt 71 in which the blade 763 of the cleaner 76 abuts on the intermediate transfer belt will be referred to as the “contact region CR”. The width of the contact region CR along a direction which is orthogonal to the travel direction D2 in which the intermediate transfer belt 71 moves (i.e., along the width direction) is equal to the width Wc1 of the cleaner blade 763, and this width Wc1 is wider than the width Wim of the image forming region 71a.

As the intermediate transfer belt 71 moves in the arrow direction D2 shown in FIG. 27, the splice 711 of the belt gradually approaches the contact region CR where the cleaner 76 abuts on the intermediate transfer belt and eventually arrives at the contact region CR. As this occurs, it is the top part P1 of the V-shaped splice located at the center that reaches the contact region CR first. As the intermediate transfer belt 71 moves further, the progressively outer section of the splice moves passed the contact region CR. The following effect is obtained as a part of the splice of the intermediate transfer belt 71 first reaches the contact region CR and the progressively outer section of the splice then moves passed the contact region CR.

The inevitably created step over the splice of the intermediate transfer belt 71 and the associated discontinuity of the friction factor on the surface of the intermediate transfer belt give rise to mechanical impact upon the blade 763, a change of a load upon a motor which drives the roller 75, etc. The impact upon the blade 763 causes deformation, damage or the like, e.g., the lapped ends of the blade 763, while a change of the load upon the motor while an image is being formed makes the intermediate transfer belt 71 rotate unevenly and results in misregistration. Particularly in the event that the splice of the belt is along a direction which is approximately orthogonal to the travel direction D2 of the intermediate transfer belt, the splice moves passed the contact region CR almost at the same time all over the contact region CR, thereby creating more intense impact. In contrast, where the structure shown in FIG. 27 is used, as only a part of the splice always moves passed the contact region CR, the impact remains merely local, which makes it possible to reduce the danger of the lapped ends, damage and the like of the blade 763 and suppress a change of the load upon the motor.

Further, the splice withdraws backward along the travel direction D2 of the intermediate transfer belt 71 with a distance toward outside the intermediate transfer belt 71, thereby attaining the effect of reducing friction between the intermediate transfer belt 71 and the blade 763 as described below.

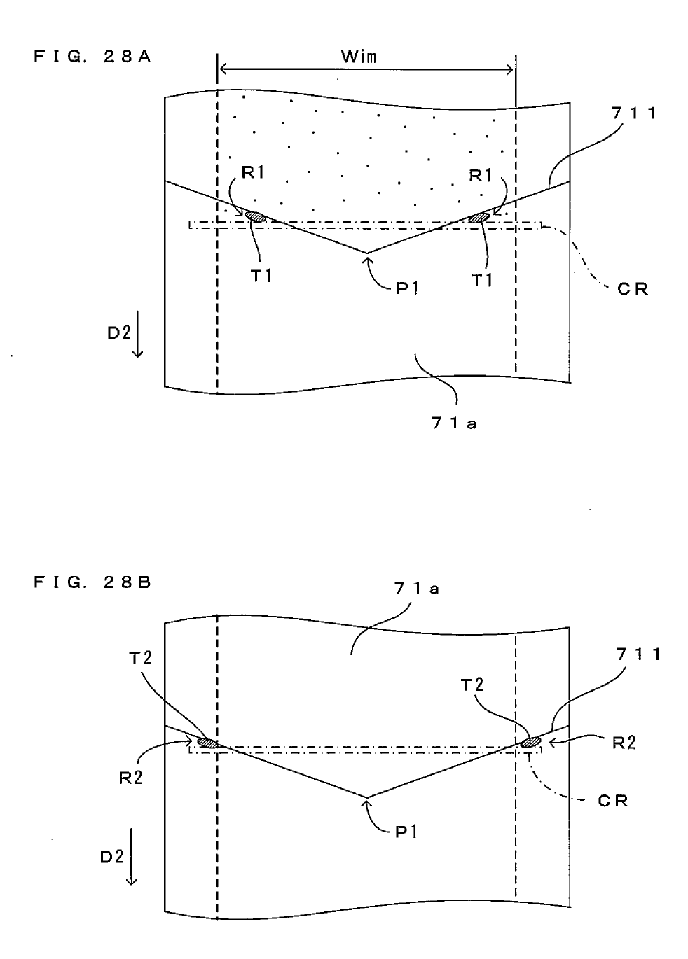

FIGS. 28A and 28B are drawings for describing the lubrication effect of toner on a belt having a splice. As shown in FIG. 28A, toner failing to get transferred to the sheet S in the secondary transfer region TR2 remains adhering to the image forming region 71a within the surface of the intermediate transfer belt 71. The blade 763 scrapes off this toner in the contact region CR. The toner thus scraped off accumulates near the contact region CR and functions as a lubricant which reduces friction between the intermediate transfer belt 71 and the blade 763.

By the way, toner accumulation at the step portion over the splice is particularly likely when the splice 711 of the intermediate transfer belt 71 moves passed the contact region CR. That is, toner tends to build up in a region R1 in which the splice 711 of the intermediate transfer belt 71 starts moving over the contact region CR. In addition, as the intermediate transfer belt 71 moves, the location of the splice over the contact region CR shifts toward outside. This subjects toner T1 accumulating in the region R1 to force which pushes the toner toward outside.

A part of toner T2 scraped off from the image forming region 71a in this manner is gradually sent toward outside as the splice 711 of the intermediate transfer belt 71 moves, and is eventually sent to a region R2 which is located outward than the image forming region 71a as shown in FIG. 28B. Since the region R2 is a region in which no ordinary image is formed, and hence, a region to which almost no toner is transported from the upstream side. Hence, this region can not primitively expect to see the lubrication effect of scraped-off toner. In reality, as for conventional image forming apparatuses, it has been confirmed that lapped ends are created often at the ends of the blade. On the contrary, the improved shape of the splice achieves supply of toner scraped off from within the image forming region even to outside the image forming region in this example. Due to the lubrication effect of the toner, it is therefore possible to securely prevent creation of lapped ends and suppress wear of the intermediate transfer belt 71 all across the width of the blade 763.

As described above, as for an apparatus which uses the intermediate transfer belt 71 having a splice, it is desirable that the splice 711 of the endless intermediate transfer belt 71 is shaped like the letter “V” with its central section protruding toward the travel direction D2 of the intermediate transfer belt 71 (i.e., with its central section convexed toward below in FIG. 27). This secures that the splice moving passed the contact region CR where the intermediate transfer belt 71 and the cleaner blade 763 contact each other is a local section, mitigates the impact upon the blade 763 and prevents the blade from getting lapped. In addition, since this makes the intermediate transfer belt 71 rotate less unevenly, misregistration decreases and the quality of an image improves.

Further, since the toner scraped off by the blade 763 from the surface of the intermediate transfer belt 71 is sent toward outside along the splice of the belt, it is possible to benefit from the lubrication effect of the toner even outside the image forming region. This further enhances the effect of preventing the blade from getting lapped and improves the effect of suppressing wear of the intermediate transfer belt 71.

Further, since the splice of the image carrier will not damage the cleaner 76 but rather plays a useful role in protecting the cleaner 76 and the intermediate transfer belt 71, it is possible to use even such an intermediate transfer belt 71 which has a splice or is slightly stepped. This makes it possible to reduce the manufacturing cost of the apparatus.

To realize this technical concept, that is, sending scraped-off toner even to outside the image forming region and accordingly achieving the lubrication effect, the shape of the belt must be such a shape which attains the function of sending toner from within the image forming region to outside the image forming region at least across the borders of the image forming region. To the extent satisfying this requirement, the splice may have a different shape from the one described above.

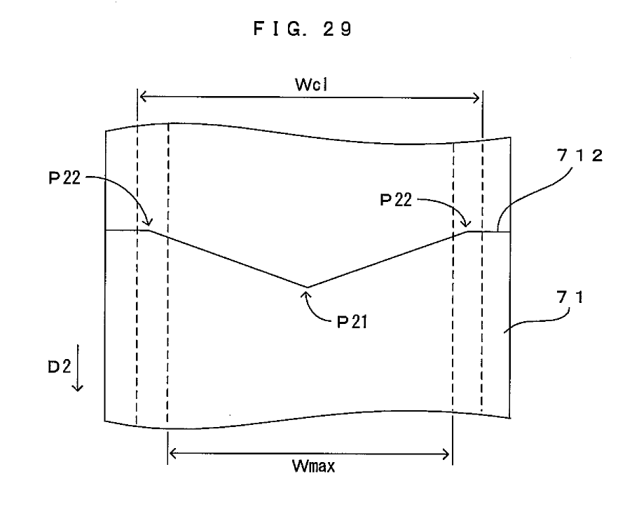

FIGS. 29 through 32 are drawings which show other examples of the shape of the splice of the belt. Of these, in the example shown in FIG. 29, the illustrated splice 712 is common to the example above in that it has a protruding section which projects like the letter “V” toward the belt travel direction D2, with the point P21 serving as an apex. This splice 712 however is bent at the points P22 in a region which is inside the ends of the blade 763 (the width Wc1), but outside the ends of an image forming region (width Wmax) which corresponds to the largest one of multiple image forming regions which correspond to sheets of different sizes. Outside the points P22, the splice extends along the direction which is approximately orthogonal to the travel direction D2 of the belt.

Even when the splice is shaped like this, toner scraped off within the image forming region is fed to outside the image forming region. Outside the points P22 however, the splice does not have any function of sending toner further toward outside. Hence, the toner sent toward outside will not be sent further toward outside even beyond the blade width Wc1, thereby preventing a cleaning defect that toner flows outside the blade 763 and remains on the intermediate transfer belt 71. In this respect, it is desirable that the points P22 are located outside the image forming region which corresponds to the largest sheet size. If the points P22 are located inside the image forming region which corresponds to the largest sheet size, no toner will be sent to outside the image forming region.

Among this type of image forming apparatuses is one which is structured to mainly form an image having a standard size, which is chosen from among plural sheet sizes, and can use sheets of the other sizes as well when necessary. For instance, there is an apparatus in which although one type of sheets (e.g., A4 size as defined in Japanese Industrial Standards) can be set to a paper reserving cassette, sheets of the other size may be set to a hand-feeder tray so that the apparatus can use sheets of other size, e.g., the legal size. In such an apparatus, the shape of the splice above may be determined based on the width of the image forming region corresponding to the standard size of sheets which is predicted to be used most frequently. The standard size is not necessarily the maximum size which the apparatus can handle.

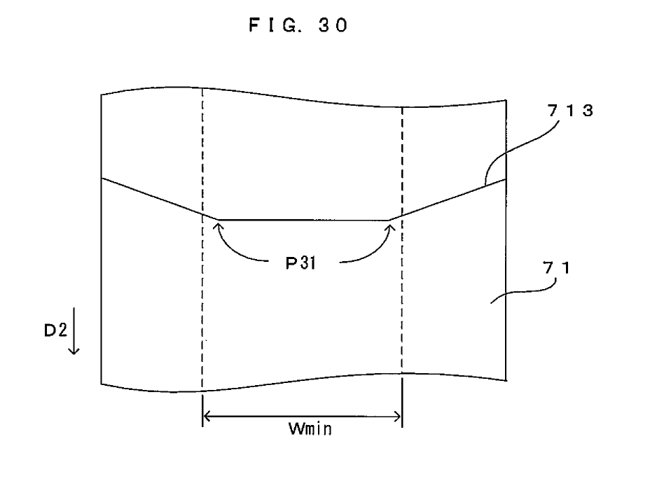

Further, in the example shown in FIG. 30, the illustrated splice 713 is approximately orthogonal to the travel direction D2 of the belt in the central section of the intermediate transfer belt 71, but is convexed toward below outside the points P31, gradually withdrawing backward. The points P31 are preferably located inside an image forming region for the smallest sheet size (width Wmin) among multiple image forming regions which correspond to sheets of different sizes. Since only the section of the splice 713 shaped like this outside the points P31 has a function of sending toner toward outside, the points P31 must be located within an area to which residual toner resulting from an image which has been formed is sent. As the points P31 are located inside the image forming region corresponding to the smallest sheet size, it is possible to stably accumulate toner all along the blade width and realize the lubrication effect regardless of the size of an image which is actually formed.

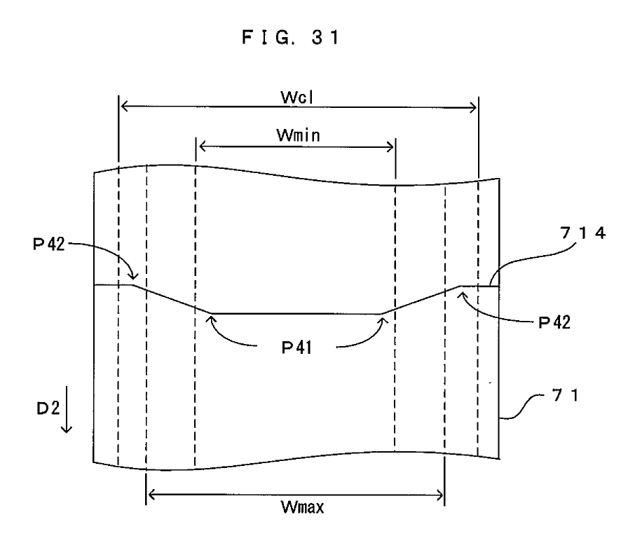

The example shown in FIG. 31 is an example attained by a combination of the concepts of FIGS. 29 and 30 described above. That is, the splice 714 in this example is approximately orthogonal to the belt travel direction D2 between the points P41, which are inside an image forming region (width Wmin) corresponding to the smallest sheet size, and outside the ends of an image forming region (width Wmax) corresponding to the largest sheet size and the points P42 which are located within a region which is inside than the ends of the blade 763 (width Wc1). On the contrary, between the points P41 and P42, the splice withdraws with a distance toward outside.

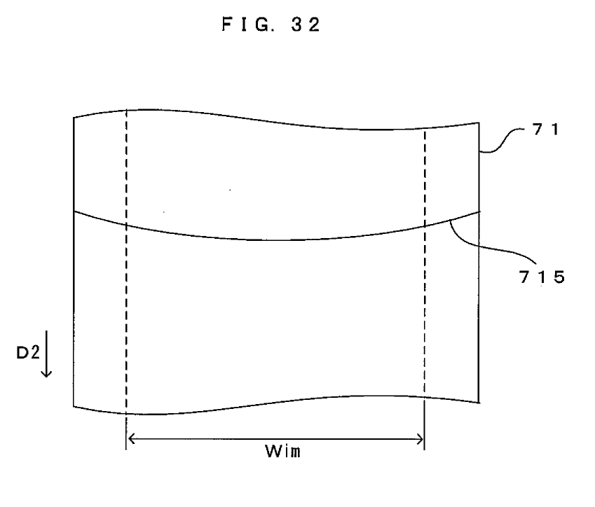

In the example shown in FIG. 32, the illustrated splice 715 is curved, with its central section protruding along the travel direction D2 of the belt. Even when the splice is shaped like this, it is possible to send toner scraped off within the image forming region to outside the image forming region and make the toner exhibit an excellent lubrication effect all along the blade width. This in turn obviates the blade from getting lapped and suppresses wear of the intermediate transfer belt 71.

Although the shape of the splice of the belt in each one of the examples above is symmetrical, the splice shape may be asymmetrical. For example, although the top part P1 of the V-shaped splice 711 shown in FIG. 27 is located approximately at the center along the width direction of the intermediate transfer belt 71, the top part P1 may be shifted to the right-hand side or the left-hand side in FIG. 27 as long as located inside the image forming region.

Further, in each one of the examples above, in the vicinity of the ends along the width direction of the intermediate transfer belt 71, i.e., outside the contact region CR, the splice extends toward the back along the belt travel direction D2 or extends along the direction which is approximately orthogonal to the belt travel direction D2. However, outside the contact region CR, the splice may be shaped so as to stretch toward the front along the belt travel direction D2. This prevents toner from getting fed even beyond the blade width Wc1.

Further, although the cleaner according to the embodiment above revolves about the predetermined rotation axis to thereby abut on and move away from the intermediate transfer belt, the abut-on/move-away mechanism is not limited to this: for instance, the cleaner, by its slide motion, may abut on and move away from the intermediate transfer member.

The shape of the toner stopper sheet will be further discussed. In a structure that the cleaner is capable of abutting on and moving away from an intermediate transfer member, since the cleaner and the intermediate transfer member are not always in mutual contact, it is difficult to accumulate toner at all times. This is because accumulated toner gets blown away owing to the abut-on/move-away motion. The embodiments above use the toner stopper sheet 764 which lines the blade 763, which abuts on and moves away from the intermediate transfer belt 71, all along the blade width. The shape of the toner stopper sheet however is not limited to this. The following will describe other examples of the structure of a cleaner which can prevent lapped ends, damage and the like without fail in an image forming apparatus which comprises an intermediate transfer member and the cleaner which abuts on and moves away from the same.

As described earlier, while the inside of the image forming region 71a of the surface of the intermediate transfer belt 71 finds a certain amount of residual toner as a result of formation of an image, there is a little such toner outside the image forming region. From this perspective, one can conclude that the toner stopper sheet is particularly effective in an area outside the image forming region. Noting this, the toner stopper sheet may be shaped as described below for instance.

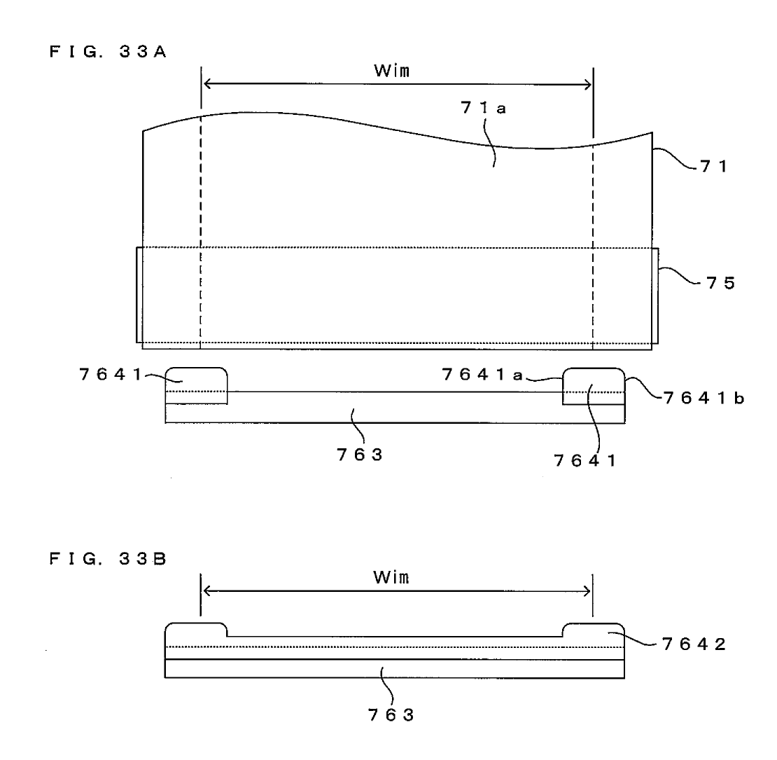

FIGS. 33A and 33B are drawings which show modified toner stopper sheets. In the example shown in FIG. 33A, the illustrated toner stopper sheet 7641 is present only at the both ends of the blade 763. The inner ends 7641a of the toner stopper sheet 7641 stretch even to inside the ends (denoted at the dotted lines) of the image forming region 71a of the intermediate transfer belt 71. On the other hand, the outer ends 7641b of the toner stopper sheet 7641 extend even to the ends of the blade 763. The reason of this is as follows.

As described earlier, since a certain amount of residual toner is always sent to inside the image forming region of the intermediate transfer belt 71 as a result of the image forming operation, in an apparatus whose secondary transfer rate is not very high for instance, a toner stopper sheet may be omitted for the abutting section between the image forming region and the blade 763. Meanwhile, since supply of residual toner is not expected outside the image forming region and the ends of the blade 763 tend to get lapped, it is essential to dispose a toner stopper sheet which prevents the blade from getting lapped. It is hence desirable that the outer ends 7641b of the toner stopper sheet 7641 extend at least to the ends of the blade 763. Further, to replenish reserved toner, it is preferable that the inner ends 7641a of the toner stopper sheet 7641 stretch even to inside at least the ends of the image forming region. This prevents a part of residual toner scraped off within the image forming region from flowing even to outside the image forming region, and permits the toner effectively serve as a lubricant outside the image forming region.

Meanwhile, in the modification in FIG. 33B, the illustrated toner stopper sheet 7642 stretches all along the width of the blade 763 and the both ends of the toner stopper sheet 7642 are higher than its central section. Describing in this in detail, from the outer-most sides to sections somewhat inside the ends of the image forming region, the toner stopper sheet 7642 protrudes longer from the blade 763 than in the other section. From similar consideration to above, it is clear that the enhanced toner reserving function outside the image forming region effectively discourages the blade 763 from getting lapped.

In the event that the toner stopper sheet has the shape shown in FIG. 33A, the toner-accumulating patch image shown in FIG. 22 is suitable. Where the toner stopper sheet has the shape shown in FIG. 33B, the toner-accumulating patch image shown in FIG. 21 or 22 is suitable.

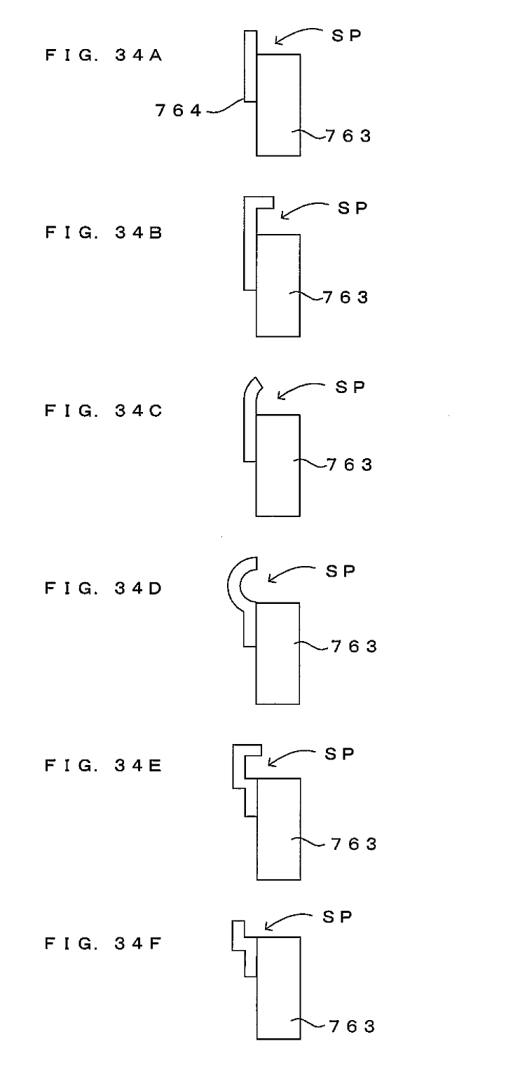

FIGS. 34A through 34F are drawings which show examples of the cross sectional shape of the toner stopper sheet. The cross sectional shape of the toner stopper sheet may be a shape like a flat plate protruding directly from the blade 763 as shown in FIG. 34A or alternatively partially curved or bent shapes as shown in the examples in FIGS. 34B through 34F. In any example, it is possible to accumulate toner in the toner reservoir space SP which is enclosed by the blade 763 and the toner stopper sheet 764, and even when the cleaner 76 is at the stand-by position where the blade 763 is off the intermediate transfer belt 71, the toner can stay near the blade tip. As this reserved toner attains the lubrication effect when the blade abuts on the intermediate transfer belt 71, it is possible to effectively suppress wear of the intermediate transfer belt 71, lapped ends, damage or the like of the blade 763. Particularly in the event that the tip portion of the toner stopper sheet 764 is directed toward the intermediate transfer belt 71 (toward the right-hand side in each drawing) as shown in FIGS. 34B through 34F, the toner reserving effect inside the toner reservoir space SP further enhances.

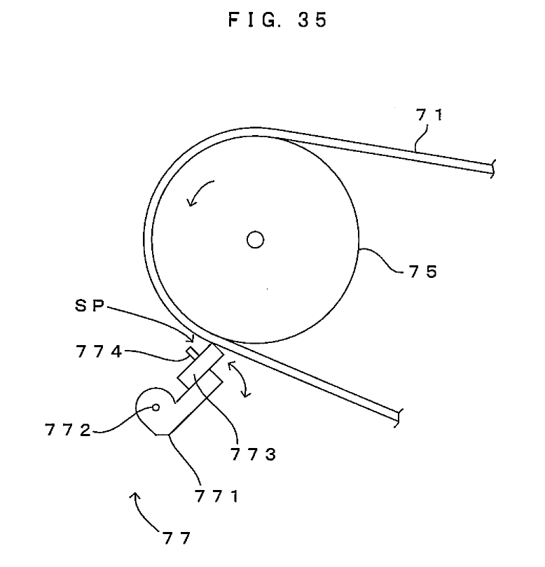

FIG. 35 is a drawing which shows other example of the structure of the cleaner. The illustrated cleaner 77 moves from below the intermediate transfer belt 71 so as to abut on the intermediate transfer belt 71. In short, as an arm member 771 swings about a rotation axis 772 as denoted at the arrow in FIG. 35, a blade 773 attached at the tip of the arm member 771 abuts on and moves away from the intermediate transfer belt 71. In such a cleaner 77, a toner stopper member 774, which projects from near the tip of the blade 773 toward the upstream side along the travel direction in which the intermediate transfer belt 71 moves, creates the toner reservoir space SP which is for reserving toner scraped off from the intermediate transfer belt 71 in the abutting section between the intermediate transfer belt 71 and the blade 773 and for holding such toner even when the cleaner 77 is away. This structure as well suppresses wear of the intermediate transfer belt 71, lapped ends or the like of the blade 773.

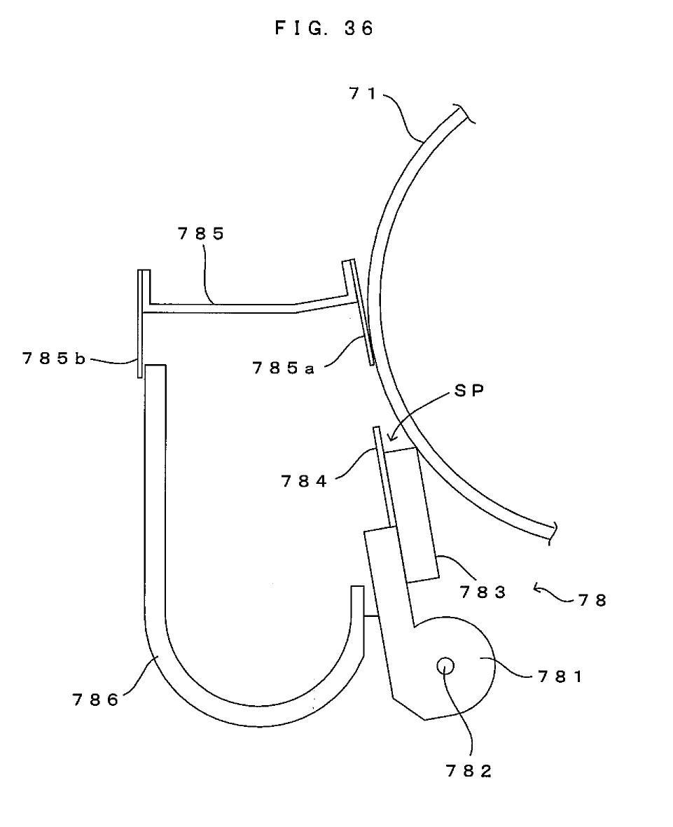

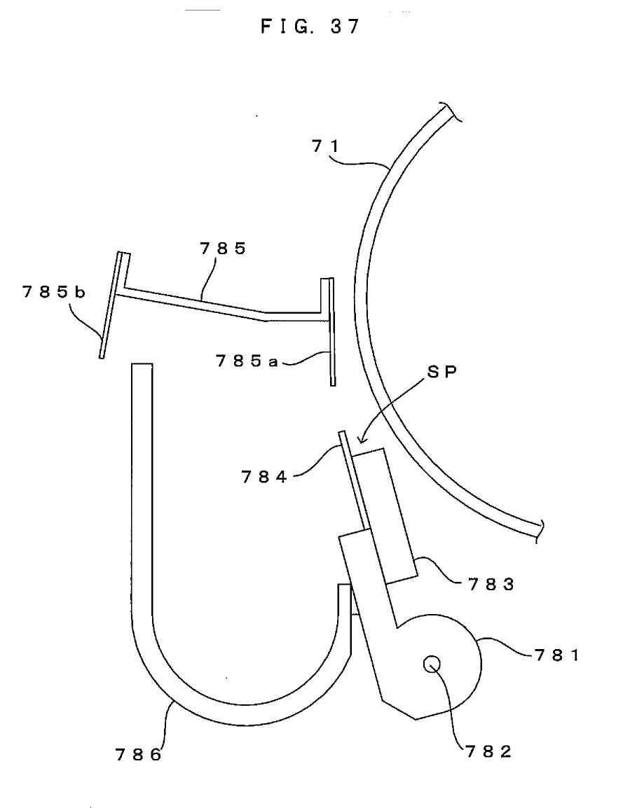

FIGS. 36 and 37 are drawings which show still other example of the structure of the cleaner. To be more specific, FIG. 36 is a drawing which shows a state that the cleaner abuts on the intermediate transfer belt 71, while FIG. 37 is a drawing which shows a state that the cleaner has moved away from the intermediate transfer belt 71. As shown in FIG. 36, the illustrated cleaner 78 comprises an arm member 781 which can freely revolve about a rotation axis 782, a blade 783 attached to the tip of the arm member 781 and a toner stopper sheet 784 projecting from the blade 783. These structures are the same as those of the arm member 761, the blade 763 and toner stopper sheet 764 according to the earlier embodiment. However, in addition to these, the cleaner 78 further comprises a top cover 785 which prevents splashing of toner scraped off from the intermediate transfer belt 71 and a housing 786 which collects the toner thus scraped off.

While scraped-off toner builds up in the toner reservoir space SP due to the toner stopper sheet 784 in a condition that the blade 783 abuts on the intermediate transfer belt 71, as the amount of toner increases, the housing 786 collects toner flowing over from the toner reservoir space SP. In consequence, there always is a constant amount of toner held inside the toner reservoir space SP. Further, although it is unavoidable to see a part of toner scraped off from the intermediate transfer belt 71 getting splashed around in a surrounding space, seal members 785a and 785b, which are disposed to the top cover 785, contact the intermediate transfer belt 71 and the housing 786 and close the opening, prevent the toner from getting blown away to outside.

Meanwhile, in a condition that the blade 783 is away from the intermediate transfer belt 71, as the top cover 785 linked to the arm member 781 moves, the seal member 785a moves away from the intermediate transfer belt 71 as shown in FIG. 37. Hence, an image carried on the intermediate transfer belt 71 will never be disturbed. Such a link mechanism can be realized in the following manner for instance.

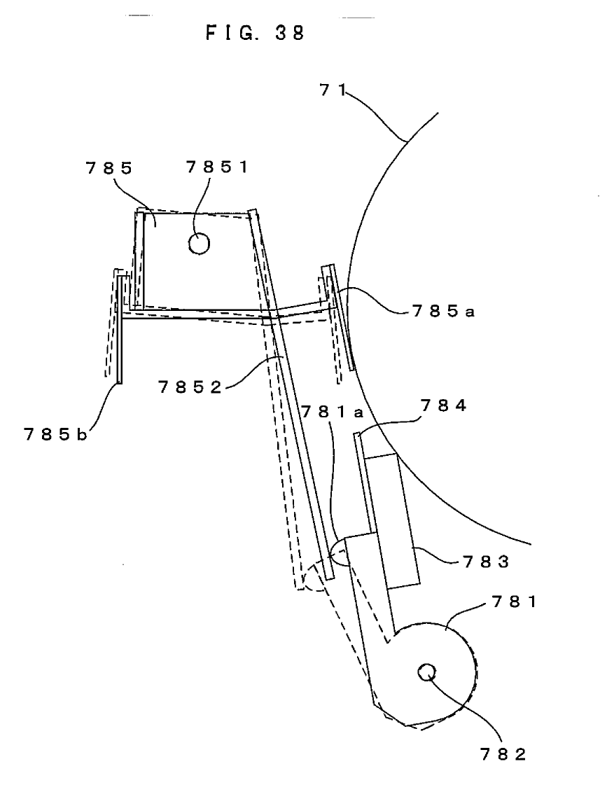

FIG. 38 is a drawing which shows an example of the link mechanism between the arm member and the top cover. The top cover 785 is held for free pivoting about a rotation axis 7851, and includes a lever part 7852 which extends toward a direction 782 of the rotation axis of the arm member 781. When the arm member 781 rotates anti-clockwise in FIG. 38 and the blade 783 accordingly moves away from the intermediate transfer belt 71, a projection 781a disposed to the arm member 781 presses down the lever part 7852. This revolves the top cover 785 clockwise about the rotation axis 7851 and the seal member 785a moves away from the intermediate transfer belt 71.

As described above, the cleaner 78 further comprises the housing 786 which collects overflowing toner and the top cover 785, in addition to what the cleaner 76 according to the earlier embodiment comprises. This attains a new effect that it is possible to securely collect scraped-off toner without splashing the toner, in addition to the effect which the earlier embodiment promises.

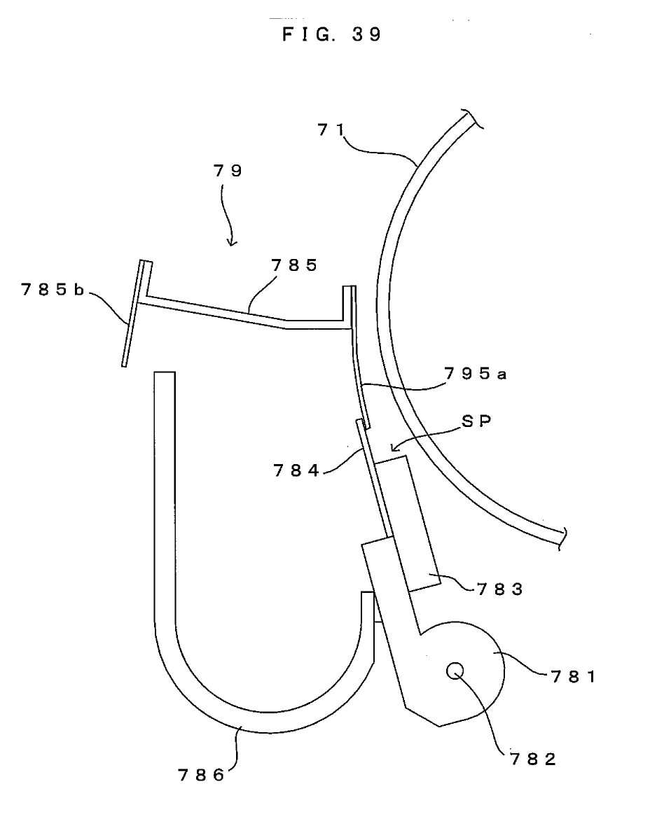

FIG. 39 is a drawing which shows a further example of the cleaner. The illustrated cleaner 79, as shown in FIG. 39, has a long seal member 795a abutting on the intermediate transfer belt 71 which lies over the toner stopper sheet 784 when the blade 783 is away from the intermediate transfer belt 71. The other structures are the same as those regarding the cleaner 78 shown in FIG. 34, and will therefore be simply denoted at the same reference symbols but will not be described in redundancy. In a condition that the blade 783 and the seal member 795a abut on the intermediate transfer belt 71, it is possible to prevent splashing of toner which has been scraped off from the intermediate transfer belt 71. As the blade 783 which used to be away from the intermediate transfer belt 71 abuts on the intermediate transfer belt 71 again, the tip of the seal member 795a scrapes off toner held in the toner reservoir space SP and sends the toner toward the intermediate transfer belt 71. This attains a better effect of sending toner which serves as a lubricant to the abutting section between the blade 783 and the intermediate transfer belt 71 at the time of re-abutting.

Although the invention has been described with reference to specific embodiments, this description is not meant to be construed in a limiting sense. Various modifications of the disclosed embodiment, as well as other embodiments of the present invention, will become apparent to persons skilled in the art upon reference to the description of the invention. It is therefore contemplated that the appended claims will cover any such modifications or embodiments as fall within the true scope of the invention.

What is claimed is:

1. An image forming apparatus, comprising:
a photosensitive member which is capable of carrying an electrostatic latent image and rotates in a predetermined direction;
a developer which visualizes with toner the electrostatic latent image carried on the photosensitive member and forms a toner image;
an intermediate transfer member which temporarily carries the toner image transferred from the photosensitive member;
a photosensitive member cleaner which abuts on a surface of the photosensitive member and removes toner adhering on the photosensitive member;
an intermediate transfer member cleaner which abuts on a surface of the intermediate transfer member and removes toner adhering on the intermediate transfer member; and
a controller which executes toner accumulating processing during which a toner-accumulating patch image including a predetermined first area and a predetermined second area is formed on the photosensitive member toner in the first area is transferred onto the intermediate transfer member and the intermediate transfer member cleaner removes the toner, thereby accumulating the toner in an abutting section between the intermediate transfer member and the intermediate transfer member cleaner, while the photosensitive member cleaner removes toner in the second area, thereby accumulating the toner in an abutting section between the photosensitive member and the photosensitive member cleaner,
wherein the first area is formed in a different surface area within the surface of the photosensitive member from an area in which the second area is created during an immediately preceding rotation of the photosensitive member.

2. The image forming apparatus of claim 1, wherein the first area is formed on the photosensitive member before the second area is formed.

3. The image forming apparatus of claim 1, wherein the first area is formed on the photosensitive member with a gap equal to or greater than a circumference of the photosensitive member measured from a rear end of the second area along a travel direction in which the photosensitive member moves.

4. The image forming apparatus of claim 1, further comprising a discharger which discharges electricity from a surface of the photosensitive member at a predetermined discharging position,
wherein a primary transfer position at which the toner image is transferred from the photosensitive member onto the intermediate transfer member, the discharging position and a cleaning position at which the photosensitive member cleaner removes toner from the surface of the photosensitive member are arranged in this order along the travel direction of the photosensitive member.

5. The image forming apparatus of claim 1, further comprising a discharger which discharges electricity from a surface of the photosensitive member,
wherein the toner-accumulating patch image is formed as the developer supplies toner to the surface of the photosensitive member as it is immediately after discharged.

6. The image forming apparatus of claim 1, wherein the controller executes the toner accumulating processing when either one of the photosensitive member and the intermediate transfer member is new.

7. An image forming apparatus, comprising:
a photosensitive member which is capable of carrying an electrostatic latent image;
a developer which visualizes with toner the electrostatic latent image carried on the photosensitive member and forms a toner image;
an intermediate transfer member which temporarily carries the toner image transferred from the photosensitive member;
a photosensitive member cleaner which abuts on a surface of the photosensitive member and removes toner adhering on the photosensitive member;
an intermediate transfer member cleaner which abuts on a surface of the intermediate transfer member and removes toner adhering on the intermediate transfer member; and
a controller which executes toner accumulating processing for accumulating toner in each one of an abutting section between the photosensitive member and the photosensitive member cleaner and an abutting section between the intermediate transfer member and the intermediate transfer member cleaner,
wherein during the toner accumulating processing,
the controller forms a predetermined toner-accumulating patch image on the photosensitive member,
a part of the toner-accumulating patch image is transferred onto the intermediate transfer member and the intermediate transfer member cleaner removes the toner-accumulating patch image, thereby accumulating toner in the abutting section between the intermediate transfer member and the intermediate transfer member cleaner,
the photosensitive member cleaner removes a remainder of the toner-accumulating patch image left on the photosensitive member without getting transferred onto the intermediate transfer member, thereby accumulating toner in the abutting section between the photosensitive member and the photosensitive member cleaner, and
a ratio of a portion of the toner-accumulating patch image transferred onto the intermediate transfer member to the toner-accumulating patch image as a whole is determined in accordance with use histories of the photosensitive member and the intermediate transfer member.

8. The image forming apparatus of claim 7, wherein an area size of the toner-accumulating patch image is constant.

9. The image forming apparatus of claim 7, wherein the controller determines an area size of the portion of the toner-accumulating patch image transferred onto the intermediate transfer member in accordance with use history of the intermediate transfer member.

10. The image forming apparatus of claim 9, wherein the area size of the portion of the toner-accumulating patch image to stay on the photosensitive member without getting transferred onto the intermediate transfer member is constant.

11. The image forming apparatus of claim 10, wherein the controller executes the toner accumulating processing when an integrated value of use amount of the photosensitive member has reached a predetermined value.

12. The image forming apparatus of claim 7, wherein an area size of the portion of the toner-accumulating patch image to stay on the photosensitive member without getting transferred onto the intermediate transfer member is determined in accordance with use history of the photosensitive member.

13. The image forming apparatus of claim 12, wherein the controller executes the toner accumulating processing when an integrated value of use amount of the intermediate transfer member has reached a predetermined value.

14. An image forming apparatus, comprising:
a photosensitive member which is capable of carrying an electrostatic latent image;
a developer which visualizes with toner the electrostatic latent image carried on the photosensitive member and forms a toner image;
an intermediate transfer member which temporarily carries the toner image transferred from the photosensitive member;
a photosensitive member cleaner which abuts on a surface of the photosensitive member and removes toner adhering on the photosensitive member;
an intermediate transfer member cleaner which abuts on a surface of the intermediate transfer member and removes toner adhering on the intermediate transfer member; and
a controller which executes toner accumulating processing for accumulating toner in each one of an abutting section between the photosensitive member and the photosensitive member cleaner and an abutting section between the intermediate transfer member and the intermediate transfer member cleaner,
wherein during the toner accumulating processing, the controller
forms a predetermined toner-accumulating patch image on the photosensitive member and a part of the toner-accumulating patch image is transferred onto the intermediate transfer member, thereby sending toner constituting the toner-accumulating patch image to each one of the abutting section between the intermediate transfer member and the intermediate transfer member cleaner and the abutting section between the photosensitive member and the photosensitive member cleaner,
determines an amount of the toner to send into the abutting section between the intermediate transfer member and the intermediate transfer member cleaner in accordance with use history of the intermediate transfer member, and
determines an amount of the toner to send into the abutting section between the photosensitive member and the photosensitive member cleaner in accordance with use history of the photosensitive member.

15. The image forming apparatus of claim 14, wherein the controller determines the amounts of the toner to send into the abutting section between the intermediate transfer member and the intermediate transfer member cleaner and the abutting section between the photosensitive member and the photosensitive member cleaner in accordance with a number of images formed and a value of a print duty of each image.

16. An image forming method according to which an electrostatic latent image on a photosensitive member is visualized with toner, a toner image is accordingly formed, and the toner image is transferred onto an intermediate transfer member, comprising:
forming a first area of a toner-accumulating patch image on the photosensitive member;
forming a second area of the toner-accumulating patch image on the photosensitive member after forming the first area;
transferring the first area from the photosensitive member onto the intermediate transfer member; and
abutting an intermediate transfer member cleaner on the intermediate transfer member to thereby remove toner adhering to the intermediate transfer member and abutting a photosensitive member cleaner on the photosensitive member to thereby remove toner adhering to the photosensitive member.

17. An image forming method according to which an electrostatic latent image on a photosensitive member is visualized with toner, a toner image is accordingly formed, and the toner image is transferred onto an intermediate transfer member, comprising:
forming a second area of a toner-accumulating patch image on the photosensitive member;
forming a first area of the toner-accumulating patch image on the photosensitive member, with a gap equal to or greater than a circumference of the photosensitive member measured from a rear end of the second area along a travel direction in which the photosensitive member moves;
transferring the first area of the toner-accumulating patch image onto the intermediate transfer member; and
abutting an intermediate transfer member cleaner on the intermediate transfer member to thereby remove toner adhering to the intermediate transfer member and abutting a photosensitive member cleaner on the photosensitive member to thereby remove toner adhering to the photosensitive member.

18. An image forming method according to which an electrostatic latent image on a photosensitive member is visualized with toner, a toner image is accordingly formed, and the toner image is transferred onto an intermediate transfer member, comprising:
forming a predetermined toner-accumulating patch image on the photosensitive member;
transferring a part of the toner-accumulating patch image onto the intermediate transfer member at a ratio determined based on use histories of the photosensitive member and the intermediate transfer member; and
abutting an intermediate transfer member cleaner on the intermediate transfer member to thereby remove toner adhering to the intermediate transfer member and abutting a photosensitive member cleaner on the photosensitive member to thereby remove toner adhering to the photosensitive member.

19. An image forming method according to which an electrostatic latent image on a photosensitive member is visualized with toner, a toner image is accordingly formed, and the toner image is transferred onto an intermediate transfer member, comprising:
forming a predetermined toner-accumulating patch image, which is constituted by an amount of toner determined in accordance with use histories of the photosensitive member and the intermediate transfer member, on the photosensitive member;
transferring a part of the toner-accumulating patch image onto the intermediate transfer member; and
abutting an intermediate transfer member cleaner on the intermediate transfer member to thereby remove the toner-accumulating patch image transferred onto the intermediate transfer member and abutting a photosensitive member cleaner on the photosensitive member to thereby remove the toner-accumulating patch image left remaining on the photosensitive member.
